(19) United States
(12) Patent Application Publication
(10) Pub. No.: US 2010/0123101 A1
(43) Pub. Date: May 20, 2010

(54) HYDROTALCITE COMPOUND, PROCESS FOR PRODUCING SAME, INORGANIC ION SCAVENGER, COMPOSITION, AND ELECTRONIC COMPONENT-SEALING RESIN COMPOSITION

(75) Inventor: Yasuharu Ono, Aichi (JP)

Correspondence Address: KRATZ, QUINTOS & HANSON, LLP, 1420 K Street, N.W., Suite 400, WASHINGTON, DC, 20005, US

(73) Assignee: TOAGOSEI CO., LTD.,, Tokyo (JP)

(21) Appl. No.: 12/597,383

(22) PCT Filed: Apr. 16, 2008
(86) PCT No.: PCT/JP2008/057450

§ 371 Date: Oct. 23, 2009

(30) Foreign Application Priority Data
Apr. 26, 2007 (JP) 2007-116787

(51) Int. Cl. C01B 31/30; C23F 11/00; C08K 3/26; H01B 1/00

(52) U.S. Cl. 252/500; 423/420.2; 252/387; 524/424

(57) ABSTRACT

The present invention is a novel hydrotalcite compound that is environmentally friendly and exhibits an excellent metal corrosion inhibiting effect by the addition of a small amount thereof, and an inorganic ion scavenger employing same; the hydrotalcite compound is represented by Formula (1), has a hydrotalcite compound peak in the powder X-ray diffraction pattern, the peak intensity at 2θ=11.4° to 11.7° being at least 3,500 cps, and has a BET specific surface area of greater than 30 m²/g.

MgₐAl_{b}(OH)_{c}(CO₃)_{d}·nH₂O (1)

In Formula (1), a, b, c, and d are positive numbers and satisfy 2a+3b−c−2d=0. Furthermore, n denotes hydration number and is 0 or a positive number.

### TECHNICAL FIELD

The present invention relates to a hydrotalcite compound, a process for producing same, and an inorganic ion scavenger, composition, electronic component-sealing resin composition, electronic component-sealing material, and electronic component that comprise the hydrotalcite compound.

### BACKGROUND ART

Conventionally, ion scavengers are added to electronic component-sealing resins, electrical component-sealing resins, resins for electrical products, etc.

For example, many LSIs, ICs, hybrid ICs, transistors, diodes, thyristors, and hybrid components thereof are sealed using an epoxy resin. Such an electronic component-sealing material is required to prevent failure due to ionic impurities in a starting material or moisture entering from outside and to have various properties such as flame retardancy, high adhesion, crack resistance, and electrical properties such as high volume resistivity.

An epoxy resin, which is widely used as an electronic component-sealing material, comprises, in addition to a main component epoxy compound, an epoxy compound curing agent, a curing accelerator, an inorganic filler, a flame retardant, a pigment, a silane coupling agent, etc., but since these starting materials often contain ionic impurities such as halogen ion and sodium ion and might adversely influence an electronic device, a small amount of ion scavenger is made to be present at the same time, thus preventing the electronic device from being adversely influenced.

In recent years, because of concerns about the environment, there have been many cases in which environmentally burdensome substances such as heavy metals have not been used as a constituent of sealing materials. Because of this, the use of antimony compounds, which have conventionally often been used as flame retardants, has been abolished, and magnesium hydroxide, etc. is being used (ref. Patent Publication 1).

In order to prevent corrosion of aluminum wiring, etc. and enhance the reliability of electronic components, adding a hydrotalcite compound or a calcined material thereof, which are inorganic anion exchangers, to an epoxy resin, etc. has been proposed for the purpose of scavenging problematic ionic impurities, in particular halogen ions (ref. Patent Publication 2).

Furthermore, making a hydrotalcite compound in the form of ultra-fine particles so as to increase the surface area and improve the ability to scavenge anions has been proposed (ref. Patent Publication 3).

Furthermore, a semiconductor sealing epoxy resin composition to which a bismuth compound anion exchanger has been added is known (ref. Patent Publication 4).

[Patent Publication 1] JP-A-2005-320446 (JP-A denotes a Japanese unexamined patent application publication.)

### [Patent Publication 2] JP-A-63-252451

[Patent Publication 3] JP-B-58-46146 (JP-B denotes a Japanese examined patent application publication.)

### [Patent Publication 4] JP-A-02-294354

### DISCLOSURE OF INVENTION

### Problems to be Solved by the Invention

The magnesium hydroxide described in Patent Publication 1 decomposes at high temperature and this reaction, which is endothermic, allows a flame retardant effect to be exhibited. However, since magnesium hydroxide might contain as an impurity sulfate ion, decomposition gradually progresses within an electronic component-sealing resin, and sulfate ion generated during the process might corrode aluminum wiring, etc., thus impairing the reliability of the semiconductor component.

Furthermore, in Patent Publication 2, a hydrotalcite compound is used as a component that traps anions such as chloride ion or bromide ion effectively; the Kyoward series manufactured by Kyowa Chemical Industry, Co., Ltd is cited as one example, and it is disclosed that the amount thereof added is preferably at least 1% of the total amount of an epoxy resin and a novolac phenol resin, hardly any effect in trapping ions being observed when it is less than 1%. That is, the ability of conventional hydrotalcite to scavenge anions is not sufficiently high, and from the viewpoint of economy and the possibility of impurities leaching out from the hydrotalcite compound itself a hydrotalcite compound having a high ability to scavenge anions has been desired.

As described in Patent Publication 3, when a hydrotalcite compound is made into ultra-fine particles, it can be expected that the specific surface area will increase and the ability to scavenge anions will improve, but when it is made into fine particles it becomes difficult to obtain one having high crystallinity, the problems of ion-exchange performance being degraded and ionic impurities easily leaching out occur, and there is the defect that the effect in preventing corrosion of aluminum wiring is insufficient.

Furthermore, when a bismuth compound described in Patent Publication 4 is used, since commercial bismuth compounds often contain nitrate ion in the compound and release the nitrate ion instead of scavenging sulfate ion, their use is limited. Moreover, there is the problem that their use is limited from the viewpoint of recycling, etc. since an alloy with copper is easily formed.

In order to make flame retardants environmentally responsive, the burden on inorganic ion scavengers in electronic component-sealing materials is increasing, but conventionally known inorganic ion scavengers have the problems described above.

It is an object of the present invention to solve the above-mentioned problems of the conventional inorganic ion scavengers, and to provide a new inorganic ion scavenger that is environmentally friendly and has high performance. More specifically, it is an object thereof to provide a novel hydrotalcite compound that exhibits an excellent metal corrosion inhibiting effect by the addition of a small amount thereof, and an inorganic ion scavenger employing same.

### Means for Solving the Problems

As a result of an intensive investigation by the present inventors in order to find a novel hydrotalcite compound that can be used in an electronic component-sealing material, etc., it has been found that it is possible to synthesize a hydrotalcite compound that has a high specific surface area and high crystallinity and from which little ionic impurity leaches out; it has been confirmed that this exhibits particularly excellent performance, and the present invention has thus been accomplished.

That is, the above-mentioned objects have been attained by [1], [4], [7], and [9] to [12] below. They are described below together with [2], [3], [5], [6], [8], and [13], and [14] which are preferred embodiments.
[1] A hydrotalcite compound represented by Formula (1), the compound having in a powder X-ray diffraction pattern a hydrotalcite compound peak, the peak intensity at 2θ=11.4° to 11.7° being at least 3,500 cps, and having a BET specific surface area of greater than 30 m²/g,

MgₐAl_{b}(OH)_{c}(CO₃)_{d}·nH₂O (1)

In Formula (1), a, b, c, and d are positive numbers and satisfy 2a+3b−c−2d=0. n denotes hydration number and is 0 or a positive number.
[2] the hydrotalcite compound according to [1] above, wherein in Formula (1) above, a/b is at least 1.8 but no greater than 2.5,
[3] the hydrotalcite compound according to [1] or [2] above, wherein the amount of ionic impurities leaching out when a leaching-out test is carried out in ion exchanged water at 125° C. for 20 hours is no greater than 500 ppm and the electrical conductivity of the leaching water is no greater than 200 μS/cm,
[4] a process for producing the hydrotalcite compound according to any one of [1] to [3] above, comprising in order a step of forming a hydrotalcite compound precursor precipitate from a metal ion aqueous solution, and a step of heating at at least 70° C. but no greater than 150° C. for at least 5 hours but no greater than 40 hours,
[5] the process for producing a hydrotalcite compound according to [4] above, wherein in the step of forming a hydrotalcite compound precursor precipitate, the metal ion aqueous solution has a temperature of at least 20° C. but no greater than 35° C.,
[6] the process for producing a hydrotalcite compound according to [4] or [5] above, wherein after the heating step it further comprises a step of drying at at least 200° C. but no greater than 350° C. for at least 0.5 hours but no greater than 24 hours,
[7] an inorganic ion scavenger comprising the hydrotalcite compound according to any one of [1] to [3] above and an inorganic cation exchanger,
[8] the hydrotalcite compound according to any one of [1] to [3] above or the inorganic ion scavenger according to [7] above, wherein in an aluminum wiring corrosion test comprising the steps below, the increase in resistance is less than 1%,
A: a step of preparing an electronic component-sealing resin composition by combining 72 parts by weight of a bisphenol epoxy resin (epoxy equivalent weight 190), 28 parts by weight of an amine-based curing agent (molecular weight 252), 100 parts by weight of fused silica, 1 part by weight of an epoxy-based silane coupling agent, and 0.25 parts by weight of a hydrotalcite compound or an inorganic ion scavenger,
B: a step of preparing an aluminum wiring sample by mixing the electronic component-sealing resin composition prepared in step A using a three roll mill, subjecting it to vacuum degassing at 35° C. for 1 hour, then applying it onto two lines of aluminum wiring printed on a glass sheet (line width 20 μm, coating thickness 0.15 μm, length 1,000 mm, line gap 20 μm, resistance about 9 kΩ) at a thickness of 1 mm, and curing it at 120° C., and
C: a step of measuring the resistance of aluminum wiring at a positive electrode between that before and that after putting the aluminum wiring sample prepared in step B in a pressure cooker under conditions of 130° C.±2° C., 85% RH (±5%), an applied voltage of 20V, and a time of 60 hours, and calculating the percentage change in resistance,
[9] a composition comprising the hydrotalcite compound according to any one of [1] to [3] above or the inorganic ion scavenger according to [7] or [8] above,
[10] an electronic component-sealing resin composition comprising the hydrotalcite compound according to any one of [1] to [3] above,
[11] an electronic component-sealing resin composition comprising the inorganic ion scavenger according to [7] or [8] above,
[12] an electronic component-sealing material formed by curing the electronic component-sealing resin composition according to [10] or [11] above,
[13] an electronic component formed by the electronic component-sealing material according to [12] above sealing a device, and
[14] the composition according to [9] above, wherein the composition is for use in a varnish, an adhesive, a paste, or a product comprising same.

### EFFECTS OF THE INVENTION

In accordance with the present invention, there can be provided a new inorganic ion scavenger that is environmentally friendly and has high performance. Specifically, there can be provided a novel hydrotalcite compound that exhibits an excellent metal corrosion inhibiting effect by the addition of a small amount thereof, and an inorganic ion scavenger employing same.

### BEST MODE FOR CARRYING OUT THE INVENTION

The present invention is explained in detail below, but the present invention is not limited thereto as long as the effects of the present invention can be obtained. Parts by weight are simply called parts. Furthermore, ‘at least A but no greater than B’ is simply called ‘A to B’. Therefore, the statement ‘A to B’ includes its end points A and B.

### Hydrotalcite Compound

The hydrotalcite compound of the present invention is one represented by Formula (1) below, having in the powder X-ray diffraction pattern a hydrotalcite compound peak, the peak intensity at 2θ=11.4° to 11.7° being at least 3,500 cps, and having a BET specific surface area of greater than 30 m²/g.

MgₐAl_{b}(OH)_{c}(CO₃)_{d}·nH₂O (1)

In Formula (1), a, b, c, and d are positive numbers and satisfy 2a+3b−c−2d=0. Furthermore, n denotes the hydration number and is 0 or a positive number.

Furthermore, one in which part of the Mg is replaced by another divalent metal ion may preferably also be used. Among said other divalent metal ions, Zn is particularly preferable.

The hydrotalcite compound of the present invention or the inorganic ion scavenger comprising same is mixed with a resin and can thereby suppress the adverse influence of ionic impurities and anions such as chloride ion that are released from the resin or enter from the outside. The hydrotalcite compound of the present invention or the inorganic ion scavenger comprising same can therefore enhance the reliability of an electronic component or an electrical component by using it for the sealing, covering, insulation, etc. thereof. Furthermore, use of the hydrotalcite compound of the present invention or the inorganic ion scavenger comprising same in a corrosion inhibitor, a stabilizer for a resin such as vinyl chloride, etc. can be expected.

Examples of the hydrotalcite compound of the present invention include those below.
Mg_{4.5}Al₂(OH)₁₃CO₃·3.5H₂O, Mg₅Al_{1.5}(OH)_{12.5}CO₃·3.5H₂O, Mg₆Al₂(OH)₁₆CO₃·4H₂O,
Mg_{4.2}Al₂(OH)_{12.4}CO₃·3.5H₂O, Mg_{4.3}Al₂(OH)_{12.6}CO₃·3.5H₂O,
Mg_{2.5}Zn₂Al₂(OH)₁₃CO₃·3.5H₂O, Mg_{4.2}Al₂(OH)_{12.4}CO₃·2.5H₂O,
Mg_{4.2}Al₂(OH)_{12.4}CO₃·H₂O, and Mg₄Al₂(OH)₁₂CO₃·3.5H₂O.

Among them, a hydrotalcite compound of Formula (1) in which a/b is at least 1.5 but no greater than 5 is preferable. When a/b is too large crystallization is slow and there is the problem that the amount of metal ion leaching out is large, and when a/b is too small excess Al becomes a double salt, thus degrading the crystallinity. It is preferable for a/b to be in the above-mentioned range since crystallization progresses quickly, the amount of metal ion leaching out is small, and the crystallinity is good. a/b is more preferably in the range of at least 1.7 but no greater than 3, and yet more preferably in the range of at least 1.8 but no greater than 2.5; particularly preferred specific examples of the hydrotalcite compound include Mg_{4.2}Al₂(OH)_{12.4}CO₃·3.5H₂O.

The hydrotalcite compound of the present invention has a BET specific surface area of greater than 30 m²/g. When the BET specific surface area of the hydrotalcite compound is 30 m²/g or less, the ability to trap anions becomes low.

Although there is no upper limit for the BET specific surface area, it is preferably 32 to 70 m²/g, and more preferably 35 to 60 m²/g. It is not desirable that the specific surface area is small since the ability to trap anions is low, but it is not desirable either that the specific surface area is too large since the flowability of the composition when dispersed in a resin might become low. It is preferable for the BET specific surface area to be in the above-mentioned range since the ability to trap anions is high and the flowability of the composition when dispersed in a resin is good.

The hydrotalcite compound of the present invention has a hydrotalcite compound peak in the powder X-ray diffraction pattern. The hydrotalcite compound shows a characteristic X-ray diffraction chart as shown in FIG. 1 of JP-A-2003-26418. That is, the hydrotalcite compound of the present invention has reflection peaks corresponding to [0 0 6], [0 0 12], [0 2 4], [0 2 10], and [1 2 5] lattice planes.

Evaluation for high crystallinity, which is a characteristic of the hydrotalcite compound of the present invention, is carried out by the X-ray count number at a specific peak position observed in the powder X-ray diffraction pattern. As shown in FIG. 1 of JP-A-2003-26418 above, the peak position on the chart is defined by a value of 284 related to the X-ray Bragg reflection angle θ; since reflection from crystal plane (006) of the hydrotalcite compound is observed at 2θ=11.4° to 11.7° as the maximum peak, the figure for the X-ray count number of this peak is defined as the peak intensity and used as an evaluation index for the degree of crystallinity.

Since the higher the crystallinity of the hydrotalcite compound the lower the solubility, there is little possibility of constituent metal ions leaching out as ionic impurities, which is preferable. When the hydrotalcite compound is amorphous, the peak intensity of the powder X-ray diffraction becomes 0; as the crystallinity increases the peak intensity increases, and when it becomes a single crystal this attains an upper limit. Although there is a possibility of variations in X-ray intensity depending on the conditions of a powder X-ray diffractometer, a hydrotalcite compound that is close to a single crystal is measured as a standard, and the magnitude of that peak intensity may be used for normalization of other measurement data. Specifically, for example, hydrotalcite DHT-4A manufactured by Kyowa Chemical Industry Co., Ltd., which is used in Comparative Example 1, has a degree of crystallization that is almost that of a single crystal, a coefficient is determined so that the measured peak intensity of DHT-4A is 8,000 cps, and normalization may be carried out by multiplying all measurement results by the same coefficient.

That is, the hydrotalcite compound of the present invention has a peak intensity at 2θ=11.4° to 11.7° of at least 3,500 cps when the peak intensity at 2θ=11.4° to 11.7° of DHT-4A (Kyowa Chemical Industry Co., Ltd.) is 8,000 cps.

The peak intensity of the hydrotalcite compound of the present invention, when the peak intensity of DHT-4A is 8,000 cps, is at least 3,500 cps, preferably at least 4,000 cps, and more preferably at least 5,000 cps.

Furthermore, the upper limit of the peak intensity at θ=11.4° to 11.7° of the hydrotalcite compound of the present invention is not particularly limited, but it is generally no greater than 20,000 cps, and preferably no greater than 15,000 cps.

With regard to the secondary particle size of the hydrotalcite compound of the present invention, the average particle size measured by a laser diffraction particle size analyzer such as, for example, a ‘Microtrac MT3000’ laser diffraction particle size analyzer manufactured by Nikkiso Co., Ltd. is used. It is not desirable for the secondary particle size to be too large since entry into a fine gap when used for sealing an electronic component, etc. is not possible, and it is not desirable for it to be too small since aggregability becomes high and dispersion in a resin becomes difficult. The secondary particle size of the hydrotalcite compound of the present invention is preferably no greater than 2 μm, more preferably 0.03 to 1.0 μm, and yet more preferably 0.05 to 0.7 μm.

Furthermore, the primary particle size of the hydrotalcite compound of the present invention may be measured using a scanning electron microscope such as, for example, a ‘JSM-6330F’ (JEOL) or a transmission electron microscope. The primary particle size of the hydrotalcite compound of the present invention is preferably no greater than 200 nm, more preferably 40 to 150 nm, and yet more preferably 55 to 120 nm. It is preferable for the primary particle size to be in the above-mentioned range since filterability is good, washing after synthesis is easy, and the performance is high.

### Metal Impurities

As magnesium and aluminum, which are starting materials for the hydrotalcite compound of the present invention, natural starting materials are often used industrially, and they might contain metal impurities as well as the magnesium and aluminum. However, it is not desirable for a heavy metal such as iron, manganese, cobalt, chromium, copper, vanadium, or nickel or a radioactive element such as uranium or thorium to be contained since there is an adverse influence in terms of the environment or in causing malfunctioning of an electronic material.

In the hydrotalcite compound of the present invention, the total content of heavy metals including the above-mentioned examples is preferably no greater than 1,000 ppm, more preferably no greater than 500 ppm, and yet more preferably no greater than 200 ppm. Furthermore, the total content of uranium and thorium is preferably no greater than 50 ppb, more preferably no greater than 25 ppb, and yet more preferably no greater than 10 ppb.

The content of metal impurities in the hydrotalcite compound may be measured by applying a dry analysis such as an X-ray fluorescence spectrometry as well as by a wet analysis method in which the hydrotalcite compound is dissolved in an acid such as nitric acid to give an aqueous solution, such as atomic absorption spectrometry or inductively coupled plasma emission spectroscopy (ICP). Among them, the ICP method is preferable since multiple elements can be measured with high sensitivity.

Water of crystallization, denoted by nH₂O in Formula (1), is removed by thermal drying, and its limit is n=0, but the water of crystallization easily returns to the original number n as a result of moisture absorption. However, once a hydrotalcite compound has gained a drying history it has an outstandingly improved ability to scavenge divalent and trivalent metal ions such as Cu ion, and it is therefore effective for preventing migration of copper wiring in an electronic material. Such a dried hydrotalcite compound and a hydrotalcite compound that has gained a drying history are also included in the hydrotalcite compound of the present application.

### Production Process

The process for producing a hydrotalcite compound of the present invention is any method as long as the above hydrotalcite compound is obtained. As an example thereof there can be cited a process for producing a hydrotalcite compound, comprising in order a step of forming a hydrotalcite compound precursor precipitate from a metal ion aqueous solution and a step of heating at at least 70° C. but no greater than 150° C. for at least 5 hours but no greater than 40 hours. The metal ion aqueous solution referred to here is an aqueous solution containing a metal ion starting material and carbonate ion and to which a basic material is added as necessary to thus give a desired pH.

More specifically, there can be cited a process in which a metal ion starting material such as a magnesium salt or an aluminum salt is dissolved in water at a predetermined charging ratio, the pH of the aqueous solution is increased in a state in which carbonate ion is contained in the solution to thus form a precipitate, and this precipitate is thermally aged, washed with water, and dried.

As the metal ion starting material, any ionic metal compound may be used as long as it is soluble in water. Examples of magnesium ion starting materials include magnesium nitrate, magnesium chloride, magnesium sulfate, magnesium hydroxide, and magnesium acetate. Among them, magnesium nitrate is particularly preferable, and a solution formed by adding nitric acid to magnesium hydroxide, magnesium oxide, magnesium carbonate, magnesium hydrogencarbonate, magnesium metal, etc. may also be used preferably.

Examples of aluminum ion starting materials include aluminum nitrate, aluminum chloride, aluminum sulfate, and aluminum hydroxide. Among them, aluminum nitrate is particularly preferable, and a solution formed by adding nitric acid to aluminum hydroxide, aluminum oxide, aluminum metal, etc. may also be used preferably.

As a metal ion starting material when producing a hydrotalcite compound having a formulation in which part of the magnesium is replaced by another metal such as zinc, various types of metal salt may also be used. It is also possible to use a double salt such as aluminum magnesium hydroxide, sodium aluminate, or potassium aluminate.

The reason that use of a nitrate starting material is preferable is that, when a sulfate or a chloride is used as a starting material, an aging reaction, which is described later, tends to progress quickly and non-uniformly, thus easily giving a hydrotalcite compound having a large specific surface area but a relatively low degree of crystallization. Furthermore, also for the reason that sulfate ion has a high tendency to remain on particles during washing, it is preferable for it not to be contained in a starting material.

When any of the metal ion starting materials is used, a hydrotalcite compound having a desired a/b ratio can be obtained by appropriately adjusting the amounts charged. When part of the magnesium is replaced by another metal such as zinc, it is also possible to obtain a hydrotalcite compound having a desired formulation by adjusting the proportions of the starting materials charged.

A precipitate may be formed by increasing the pH, of an aqueous solution in which predetermined charging proportions of metal ion starting materials are dissolved in water, in a state in which carbonate ion is contained. This precipitate is called a hydrotalcite compound precursor. The pH when forming a hydrotalcite compound precursor precipitate in the present invention is preferably 5 to 14, and more preferably 10 to 13.5. It is preferable for the pH to be at least 5 since it is easy to form a precipitate. It is also preferable for the pH to be no greater than 14 since the amount of alkali used is small, and this is economical.

In order to increase the pH of the aqueous solution, a method in which a basic material such as ammonia, an alkali metal oxide, an alkali metal hydroxide, an alkaline earth metal oxide, or an alkaline earth metal hydroxide is added may be used. Among them, a method in which an alkali metal hydroxide is added is preferable since it is simple.

The alkali metal hydroxide referred to here is sodium hydroxide or potassium hydroxide, and is preferably sodium hydroxide.

As a method for introducing carbonate ion, either a method in which a carbonate or a hydrogencarbonate such as sodium carbonate, potassium carbonate, sodium hydrogencarbonate, or potassium hydrogencarbonate is dissolved or a method in which carbon dioxide is dissolved may be used preferably. Among them, a method in which sodium carbonate is added is preferable.

The basic material and the carbonate ion source may be added separately to an aqueous solution of a metal starting material (metal starting material aqueous solution), but it is preferable for them to be added at the same time with fixed proportions since the formulation of the precipitate easily becomes fixed. As a particularly preferred combination, there can be cited a method in which a basic aqueous solution containing both sodium hydroxide and sodium carbonate is added to a metal starting material aqueous solution to thus give a predetermined pH. The sodium hydroxide/sodium carbonate ratio by weight in this case is preferably 11 to 1.2, more preferably 5.7 to 1.4, and yet more preferably 3.8 to 1.6, and a hydrotalcite compound precursor precipitate can be obtained by adding an aqueous solution with a fixed ratio to a metal starting material aqueous solution until a predetermined pH is attained.

The temperature of the aqueous solution when a hydrotalcite compound precursor precipitate is formed is preferably 1° C. to 100° C. for economic reasons, but from the viewpoint of performance of a finally obtained hydrotalcite compound it is preferably 10° C. to 80° C., and more preferably 20° C. to 60° C.

When half-finished crystallization does not occur in the precursor stage, since crystallization in the subsequent heating (thermal aging) stage progresses uniformly, a hydrotalcite compound having better performance can be obtained. Within the preferred temperature range, a particularly preferred temperature range is therefore a relatively low temperature range, and when a hydrotalcite compound precursor precipitate is formed at 20° C. to 35° C. a particularly preferred hydrotalcite compound is obtained.

The duration for forming a hydrotalcite compound precursor precipitate is not particularly limited, and is preferably 5 min to 2 hours, more preferably 10 min to 1.5 hours, and yet more preferably 15 min to 1 hour. It is preferable for the duration for forming a hydrotalcite compound precursor precipitate to be in the above-mentioned range since a precipitate can be formed sufficiently and the time efficiency is good.

In the present invention, when a hydrotalcite compound precursor is precipitated, it is preferable for a water-soluble ammonium salt not to be added to the metal ion aqueous solution. When a water-soluble ammonium salt is added, the crystallinity might become low, and it is also preferable for a water-soluble ammonium salt not to be added from the viewpoint of the environment since a large amount of nitrogen-containing effluent is formed.

Subsequently, the hydrotalcite compound precursor precipitate is aged by heating. With regard to the temperature for thermal aging, in a conventional process for producing a hydrotalcite compound a method in which aging is carried out at a high temperature of at least 170° C. is commonly used, but when the aging temperature is too high, particles grow to have a large particle size, the specific surface area becomes small, growth of crystals is non-uniform, it is easy for particles having low crystallinity to remain, and impurities therefore easily leach out. In the present invention, it is preferable to carry out aging at a relatively low temperature; this enables crystallinity to be increased uniformly while preventing the particle size from growing, that is, while keeping a high specific surface area. However, when the temperature is too low, it takes a long time to carry out aging, which is not economical; the aging temperature is preferably 70° C. to 150° C., and more preferably 80° C. to 120° C., and it is particularly preferably between 90° C. to 105° C. since the temperature can be attained using a normal reactor without using a pressure-resistant reactor such as an autoclave.

A preferred aging time when a hydrotalcite compound precursor precipitate is thermally aged cannot be generalized since it greatly depends on the starting materials. It is usually 5 to 40 hours, but when the starting material is a chloride or a sulfate, since the aging reaction progresses quickly, it is preferably 5 to 24 hours, and more preferably 6 to 18 hours. When the starting material is a nitrate, since the aging reaction is slow, the aging time is preferably 10 to 30 hours, and more preferably 16 to 24 hours, and in the case of mixed starting materials, the time is in a middle range of the above ranges. A combination that gives the most preferred result is a case in which a nitrate is used as a starting material and the aging time is 6 to 24 hours.

It is preferable to use ion exchanged water when washing a hydrotalcite compound thus synthesized, and washing is preferably carried out sufficiently until the electrical conductivity of the liquid used for washing becomes 100 μS/cm or below, and more preferably 50 μS/cm or below.

The temperature when drying a hydrotalcite compound that has been washed with water may be any as long as it is no greater than 350° C. It is preferably 70° C. to 330° C., and more preferably 90° C. to 300° C.

It is preferable for the drying temperature to be at least 70° C. since the time taken for drying is short. It is also preferable for the drying temperature to be no greater than 350° C. since carbonate ion in the hydrotalcite is not released, thus maintaining the crystal structure and giving high crystallinity.

Furthermore, a dried hydrotalcite in which the water of crystallization denoted by nH₂O in Formula (1) is reduced is preferable since the ability to scavenge divalent and trivalent metal ions such as Cu ion is outstandingly improved even after it returns to the original number n as a result of moisture absorption, and in order to obtain such an effect drying is preferably carried out at 200° C. to 350° C. for 0.5 to 40 hours, and more preferably at 200° C. to 300° C. for 1 to 24 hours. Overall, it is particularly preferable to carry out drying of the hydrotalcite compound at 200° C. to 300° C. for 1 to 24 hours.

### Ionic Impurities

The hydrotalcite compound of the present invention preferably contains few ionic impurities that leach out into water. With regard to these ionic impurities, there are anions such as sulfate ion, nitrate ion, and chloride ion and cations such as sodium ion and magnesium ion.

A method for measuring the amount of ionic impurities leaching out from the hydrotalcite compound into water is as follows:

A sealable polytetrafluoroethylene pressure-resistant container is charged with 5 g of a sample and 50 mL of ion exchanged water, sealed, and heated at 125° C. for 20 hours. After cooling, this solution is filtered using a membrane filter having a pore size of 0.1 μm, the sulfate ion, nitrate ion, and chloride ion concentrations in the filtrate are measured by ion chromatography, and the sodium ion and magnesium ion concentrations are measured by ICP. The sum of all the measurement values is multiplied by ten, and this numerical value is defined as the amount of ionic impurities (ppm).

### Ion Chromatography Analysis Conditions

Measurement equipment: model DX-300 manufactured by DIONEX
Separating column: lonPac AS4A-SC (manufactured by DIONEX)
Guard column: lonPac AG4A-SC (manufactured by DIONEX)
Eluent: 1.8 mM Na₂CO₃/1.7 mM NaHCO₃ aqueous solution
Flow rate: 1.5 mL/min
Suppressor: ASRS-I (recycle mode)

Sulfate ion, nitrate ion, and chloride ion were measured under the above-mentioned analysis conditions.

### ICP Emission Spectroscopy

Sodium ion and magnesium ion concentrations were measured by an analytical method in accordance with JIS K 0116-2003.

In the present invention, the amount of ionic impurities leaching out from the hydrotalcite compound is the sum of the amounts of the ionic impurities measured above. It is not preferable for the amount of ionic impurities to exceed 500 ppm since the reliability of an electronic material is adversely influenced, and for the hydrotalcite compound of the present invention it is preferably no greater than 500 ppm, more preferably no greater than 100 ppm, and yet more preferably no greater than 50 ppm.

### Chloride Ion Exchange Capacity

In the present invention, the chloride ion exchange capacity is measured using hydrochloric acid.

Method for measuring chloride ion exchange capacity of a hydrotalcite compound:

A polyethylene bottle is charged with 1 g of a sample and 50 mL of a 0.1 mol/L concentration hydrochloric acid aqueous solution, hermetically sealed, and shaken at 40° C. for 24 hours. Subsequently, this solution is filtered using a membrane filter having a pore size of 0.1 μm, and the chloride ion concentration of this filtrate is measured by ion chromatography. The chloride ion exchange capacity (meq/g) of the hydrotalcite compound is determined from the above measurement value and a value obtained by carrying out the same measurement procedure for chloride ion concentration without adding a sample.

The chloride ion exchange capacity of the hydrotalcite compound of the present invention is preferably at least 1.0 meq/g, more preferably at least 1.2 meq/g, and yet more preferably at least 1.5 meq/g, and is preferably no greater than 10 meq/g. It is preferable for the chloride ion exchange capacity to be in this range since the reliability of an electronic material can be maintained.

### Electrical Conductivity

The electrical conductivity of a supernatant from the hydrotalcite compound of the present invention is preferably no greater than 200 μS/cm, more preferably no greater than 150 μS/cm, and yet more preferably no greater than 100 μS/cm.

A method for measuring the electrical conductivity of the supernatant is as follows:

5 g of a hydrotalcite compound is placed in 50 g of ion exchanged water, treated at 125° C. for 20 hours, and filtered, and the electrical conductivity of the supernatant is measured using an electrical conductivity meter.

### Inorganic Ion Scavenger

The inorganic ion scavenger of the present invention may comprise, in addition to the hydrotalcite compound of the present invention, an inorganic cation exchanger. In accordance with use of the hydrotalcite compound of the present invention in combination with an inorganic cation exchanger, the performance in scavenging anions can be enhanced, and an effect in scavenging cations can also be increased, which is a preferred method.

In the present invention, with regard to the inorganic cation exchanger, any inorganic substance having cation exchange properties may be used as long as the performance of the hydrotalcite compound is not impaired. Specific examples of the inorganic cation exchanger include antimonic acid (antimony pentaoxide hydrate), niobic acid (niobium pentaoxide hydrate), manganese oxide, zirconium phosphate, titanium phosphate, tin phosphate, cerium phosphate, zeolites, and clay minerals, and among them antimonic acid (antimony pentaoxide hydrate), zirconium phosphate, and titanium phosphate are preferable.

In the inorganic ion scavenger of the present invention, the mixing ratio of the hydrotalcite compound and the inorganic cation exchanger is not particularly limited. For example, relative to 100 parts by weight of the hydrotalcite compound, the inorganic cation exchanger is preferably no greater than 400 parts by weight, and more preferably no greater than 100 parts by weight.

Addition of the hydrotalcite compound of the present invention and the inorganic cation exchanger may be carried out individually when preparing an electronic component-sealing resin composition, or they may be uniformly mixed in advance. It is preferable to mix them in advance and use as an inorganic ion scavenger.

It is preferable to do so since the combined effect of the two ion exchangers can be further exhibited.

### Composition

The composition of the present invention comprises the hydrotalcite compound of the present invention or the ion scavenger of the present invention. Other components are not particularly limited, and may be selected appropriately according to the intended application.

The composition of the present invention may be used for sealing an electronic component and sealing an electrical component. It may also be used in a varnish, an adhesive, a paste, and a product containing same. Details thereof are described later.

### Electronic Component-Sealing Resin Composition

The electronic component-sealing resin composition referred to here is a general term for resin compositions that are used by curing them in intimate contact with the entirety or part of a variety of electronic components such as, for example, LSIs, ICs, hybrid ICs, transistors, diodes, thyristors, and hybrid components thereof in order to protect these electronic components from ionic contamination from the outside and degradation due to moisture, heat, etc.

With regard to a resin used in an electronic component-sealing resin composition comprising the hydrotalcite compound or the inorganic ion scavenger of the present invention, it may be either a thermosetting resin such as a phenolic resin, a urea resin, a melamine resin, an unsaturated polyester resin, or an epoxy resin, or a thermoplastic resin such as polyethylene, polystyrene, vinyl chloride, or polypropylene, and a thermosetting resin is preferable. As the thermosetting resin used in the electronic component-sealing resin composition of the present invention, a phenolic resin or an epoxy resin is preferable, and an epoxy resin is particularly preferable.

The epoxy resin may be used without limitation as long as it is one that is used as an electronic component-sealing resin. For example, the type thereof is not particularly limited as long as it has at least two epoxy groups per molecule and is curable, and any resin used as a molding material, such as a phenol novolac type epoxy resin, a bisphenol A epoxy resin, or an alicyclic epoxy resin, may be used. Furthermore, in order to enhance the moisture resistance of the electronic component-sealing resin composition of the present invention it is preferable to use as the epoxy resin one having a chloride ion content of no greater than 10 ppm and a hydrolyzable chlorine content of no greater than 1,000 ppm. The chloride ion content means the inorganic chlorine (or inorganic chlorine referred to as ionic chlorine) content defined in JIS-7243-3, and the hydrolyzable chlorine content means the easily saponifiable chlorine content defined in JIS-7243-2.

It is preferable for the epoxy resin to be used in combination with a curing agent and a curing accelerator. As the curing agent in this case, any substance known as a curing agent for an epoxy resin composition may be used, and preferred specific examples thereof include an acid anhydride, an amine type curing agent, and a novolac type curing agent. Furthermore, as the curing accelerator, any substance known as a curing accelerator for an epoxy resin composition may be used, and preferred specific examples thereof include amine type, phosphorus type, and imidazole type accelerators.

The electronic component-sealing resin composition of the present invention may comprise as necessary a component known as one added to a molding resin. Examples of this component include an inorganic filler, a flame retardant, a coupling agent, a colorant, and a mold release agent. All of these components are known as components added to an epoxy molding resin. Preferred specific examples of the inorganic filler include crystalline silica powder, quartz glass powder, fused silica powder, alumina powder, and talc, and among them crystalline silica powder, quartz glass powder, and fused silica powder are preferable since they are inexpensive. Examples of the flame retardant include antimony oxide, a halogenated epoxy resin, magnesium hydroxide, aluminum hydroxide, a red phosphorus type compound, and a phosphoric acid ester type compound, examples of the coupling agent include silane types and titanium types, and examples of the mold release agent include waxes such as an aliphatic paraffin and a higher fatty alcohol.

The electronic component-sealing resin composition comprising the hydrotalcite compound or the inorganic ion scavenger of the present invention exhibits its effect particularly effectively when the composition is exposed to a high temperature of 100° C. or higher. That is, an electronic component-sealing resin composition or various types of additives contained therein readily release an anion such as chloride ion or sulfate ion when exposed to high temperature, thus causing the reliability to deteriorate. With respect to an electronic component-sealing resin composition for which the temperature is 100° C. or higher, and even 150° C. or higher, the hydrotalcite compound of the present invention acts particularly effectively.

The electronic component-sealing resin composition of the present invention may comprise, other than the above-mentioned components, a reactive diluent, a solvent, a thixotropy-imparting agent, etc. Specific examples of the reactive diluent include butylphenyl glycidyl ether, specific examples of the solvent include methyl ethyl ketone, and specific examples of the thixotropy-imparting agent include an organically modified bentonite.

With regard to the mixing proportion of the hydrotalcite compound or the inorganic ion scavenger of the present invention, it is preferably 0.01 to 10 parts relative to 100 parts of the electronic component-sealing resin composition, more preferably 0.05 to 5 parts, and yet more preferably 0.05 to 0.7 parts. It is preferable for it to be at least 0.01 parts since there is an effect in enhancing the removal of anions. It is also preferable for it to be no greater than 10 parts since it is economical and in addition a sufficient effect can be obtained.

The electronic component-sealing resin composition of the present invention can easily be obtained by mixing the above-mentioned starting materials by a known method, and is obtained by, for example, appropriately mixing each of the above-mentioned starting materials, kneading this mixture in a heated state by a kneader to give a partially cured resin composition, cooling this to room temperature, then grinding it by known means, and tabletting as necessary.

The hydrotalcite compound or the inorganic ion scavenger of the present invention may be used in various applications such as sealing, covering, insulation, etc. of an electronic component or an electrical component. Furthermore, it may also be used in a corrosion inhibitor, a stabilizer for a resin such as vinyl chloride, etc.

An electronic component-sealing resin composition to which the hydrotalcite compound or the inorganic ion scavenger of the present invention is added may be used in a case in which a device, for example, an active device such as a semiconductor chip, a transistor, a diode, or a thyristor or a passive device such as a capacitor, a resistor, or a coil is mounted on a support member such as a lead frame, a wired tape carrier, a wiring board, glass, or a silicon wafer. The electronic component-sealing resin composition of the present invention may also be used effectively with a printed wiring board.

As a method for sealing a device using the electronic component-sealing resin composition of the present invention, a low pressure transfer molding method is the most common, but an injection molding method, a compression molding method, etc. may also be used.

### Application to Wiring Board

A wiring board is produced by forming a printed wiring substrate utilizing the thermosetting resin such as an epoxy resin, etc., adhering a copper foil, etc. thereto, and forming a circuit by etching, etc. However, in recent years there have been problems with corrosion and poor insulation due to an increase in density of the circuit, layering of circuits, making an insulating layer film thinner, etc. Such corrosion can be prevented by adding the hydrotalcite compound or the inorganic ion scavenger of the present invention when producing a wiring board. Furthermore, corrosion, etc. of a wiring board can be prevented by adding the hydrotalcite compound or the inorganic ion scavenger of the present invention to an insulating layer for a wiring board. From such viewpoints, a wiring board comprising the hydrotalcite compound or the inorganic ion scavenger of the present invention can suppress the occurrence of defective products due to corrosion, etc. It is preferable to add 0.05 to 5 parts of the hydrotalcite compound or the inorganic ion scavenger of the present invention relative to 100 parts of resin solids content of a wiring board or an insulating layer for a wiring board.

### Addition to Adhesive

Electronic components, etc. are mounted on a substrate such as a wiring board using an adhesive. By adding the hydrotalcite compound or the inorganic ion scavenger of the present invention to this adhesive, the occurrence of defective products due to corrosion, etc. can be suppressed. It is preferable to add 0.05 to 5 parts of the hydrotalcite compound or the inorganic ion scavenger of the present invention relative to 100 parts of resin solids content of the adhesive.

By adding the hydrotalcite compound or the inorganic ion scavenger of the present invention to a conductive adhesive, etc. used when wiring or connecting an electronic component, etc. to a wiring board, defects due to corrosion, etc. can be suppressed. Examples of the conductive adhesive include one containing a conductive metal such as silver. It is preferable to add 0.05 to 5 parts of the hydrotalcite compound or the inorganic ion scavenger of the present invention relative to 100 parts of resin solids content of the conductive adhesive.

### Addition to Varnish

An electrical product, a printed wiring board, an electronic component, etc. may be produced using a varnish comprising the hydrotalcite compound or the inorganic ion scavenger of the present invention. The hydrotalcite compound of the present invention may in particular be suitably used in an insulating varnish. The insulating varnish includes one for surface coating such as a varnish for enamel wiring, one for interior impregnation such as one for magnet coil impregnation, and a coating for varnished cloth or a varnished tube, and the application thereof is not particularly limited.

Examples of the varnish include one containing as a main component a thermosetting resin such as an epoxy resin. It is preferable to add 0.05 to 5 parts of the hydrotalcite compound or the inorganic ion scavenger of the present invention relative to 100 parts of the resin solids content.

### Addition to Paste

The hydrotalcite compound or the inorganic ion scavenger of the present invention may be added to a paste containing silver powder, etc. The paste is used as an adjuvant for soldering, etc. in order to improve adhesion between metals that are to be connected. This enables the occurrence of a corrosive material generated from the paste to be suppressed. It is preferable to add of 0.05 to 5 parts by weight of the hydrotalcite compound or the inorganic ion scavenger of the present invention relative to 100 parts by weight of resin solids content of the paste.

### EXAMPLES

The present invention is explained in further detail below by reference to Examples and Comparative Examples, but the present invention is not limited thereto. Furthermore, unless otherwise specified % denotes wt %, ppm denotes wt ppm, and parts denotes parts by weight.

### Example 1

134.6 g of magnesium nitrate hexahydrate and 93.8 g of aluminum nitrate nonahydrate were dissolved in 200 mL of ion exchanged water, and while maintaining this solution at 25° C. the pH was adjusted to 10.3 by adding a solution of 97.4 g of sodium carbonate and 120 g of sodium hydroxide dissolved in 1 L of ion exchanged water. A precipitate was quickly formed, but stirring was continued for 1 hour while keeping the temperature at 25° C. Aging was then carried out at 98° C. for 24 hours. After cooling, the precipitate was washed with ion exchanged water, thus giving a hydrotalcite compound (hereinafter, called compound A). When an analysis was carried out on compound A, it was found to be Mg_{4.5}Al₂(OH)₁₃CO₃·3.5H₂O.

A powder X-ray measurement of this compound was carried out using a RINT 2400V type powder X-ray diffractometer (XRD) manufactured by Rigaku Corporation. The measurement conditions were 40 kV and 40 mA using copper as an X-ray emission target. The diffraction pattern thereof is shown in FIG. 1. The compound was found to have a peak characteristic of a hydrotalcite, and the peak intensity at 2θ=11.52° was 6,500 cps.

### Method for Analyzing Compound A

(1) Compound A was dissolved in nitric acid, and magnesium ion and aluminum concentrations were measured by ICP emission spectrophotometry using an analytical method in accordance with JIS K0116-2003.
(2) CHN elemental analysis of compound A was carried out, and the carbon content was measured to give a carbonate content.
(3) Compound A was dried at 250° C. for 24 hours, the decrease in weight was measured, and the water of crystallization content was determined.
(4) Compound A was calcined at 550° C. for 24 hours, and the total amount of CO₃ and OH was measured from the decrease in weight. The composition of compound A was calculated from these four results.

### Example 2

134.6 g of magnesium nitrate hexahydrate and 93.8 g of aluminum nitrate nonahydrate were dissolved in 200 mL of ion exchanged water, and while maintaining this solution at 25° C. the pH was adjusted to 11 with a solution of 37.1 g of sodium carbonate and 120 g of sodium hydroxide dissolved in 1 L of ion exchanged water. A precipitate was quickly formed, but stirring was continued for 1 hour while keeping the temperature at 25° C. Aging was then carried out at 98° C. for 24 hours. After cooling, the precipitate was washed with ion exchanged water, thus giving a hydrotalcite compound (hereinafter, called compound B). When an analysis was carried out on compound B, it was found to be Mg_{4.2}Al₂(OH)_{12.4}CO₃·3.5H₂O.

A powder X-ray diffraction (XRD) measurement of compound B was carried out. The diffraction pattern thereof is shown in FIG. 2.

The compound was found to have a hydrotalcite peak, and the peak intensity at 2θ=11.52° was 6,200 cps.

### Example 3

134.6 g of magnesium nitrate hexahydrate and 93.8 g of aluminum nitrate nonahydrate were dissolved in 200 mL of ion exchanged water, and while maintaining this solution at 25° C. the pH was adjusted to 10 with a solution of 37.1 g of sodium carbonate and 120 g of sodium hydroxide dissolved in 1 L of ion exchanged water. A precipitate was quickly formed, but stirring was continued for 1 hour while keeping the temperature at 25° C. Aging was then carried out at 95° C. for 24 hours. After cooling, the precipitate was washed with ion exchanged water, thus giving a hydrotalcite compound (hereinafter, called compound C). When an analysis was carried out on this compound, it was found to be Mg_{4.2}Al₂(OH)_{12.4}CO₃·3.5H₂O.

A powder X-ray diffraction (XRD) measurement of this compound was carried out. The diffraction pattern thereof is shown in FIG. 3. The compound was found to have a hydrotalcite peak, and the peak intensity at 2θ=11.52° was 5,800 cps.

### Example 4

153.8 g of magnesium nitrate hexahydrate and 75.0 g of aluminum nitrate nonahydrate were dissolved in 200 mL of ion exchanged water, and while maintaining this solution at 25° C. the pH was adjusted to 13 with a solution of 73.1 g of sodium carbonate and 120 g of sodium hydroxide dissolved in 1 L of ion exchanged water. A precipitate was quickly formed, but stirring was continued for 1 hour while keeping the temperature at 25° C. Aging was then carried out at 95° C. for 24 hours. After cooling, the precipitate was washed with ion exchanged water, thus giving a hydrotalcite compound (hereinafter, called compound D). When an analysis was carried out on compound D, it was found to be Mg₆Al₂(OH)₁₆CO₃·4H₂O.

A powder X-ray diffraction (XRD) measurement of compound D was carried out. The diffraction pattern thereof is shown in FIG. 4. The compound was found to have a hydrotalcite peak, and the peak intensity at 2θ=11.52° was 5,000 cps.

### Example 5

74.6 g of magnesium chloride hexahydrate and 57.3 g of aluminum sulfate 14 to 16 hydrate were dissolved in 200 mL of ion exchanged water, and while maintaining this solution at 25° C. the pH was adjusted to 13 with a solution of 37.1 g of sodium carbonate and 120 g of sodium hydroxide dissolved in 1 L of ion exchanged water. A precipitate was quickly formed, but stirring was continued for 1 hour while keeping the temperature at 25° C. Aging was then carried out at 98° C. for 6 hours. After cooling, the precipitate was washed with ion exchanged water, thus giving a hydrotalcite compound (hereinafter, called compound E). When an analysis was carried out on compound E, it was found to be Mg_{4.2}Al₂(OH)_{12.4}CO₃·3.5H₂O.

A powder X-ray diffraction (XRD) measurement of compound E was carried out. The diffraction pattern thereof is shown in FIG. 5. The compound was found to have a hydrotalcite peak, and the peak intensity at 2θ=11.52° was 4,000 cps.

### Example 6

85.4 g of magnesium chloride hexahydrate and 56.7 g of aluminum sulfate 14 to 16 hydrate were dissolved in 200 mL of ion exchanged water, and while maintaining this solution at 25° C. the pH was adjusted to 13 with a solution of 37.1 g of sodium carbonate and 120 g of sodium hydroxide dissolved in 1 L of ion exchanged water. A precipitate was quickly formed, but stirring was continued for 1 hour while keeping the temperature at 25° C. Aging was then carried out at 98° C. for 6 hours. After cooling, the precipitate was washed with ion exchanged water, thus giving a hydrotalcite compound (hereinafter, called compound F). When an analysis was carried out on compound F, it was found to be Mg_{4.5}Al₂(OH)₁₃CO₃·3.5H₂O.

A powder X-ray diffraction (XRD) measurement of compound F was carried out. The diffraction pattern thereof is shown in FIG. 6. The compound was found to have a hydrotalcite peak, and the peak intensity at 2θ=11.52° was 4,500 cps.

### Example 7

134.6 g of magnesium nitrate hexahydrate and 93.8 g of aluminum nitrate nonahydrate were dissolved in 200 mL of pure water, and while maintaining this solution at 40° C. the pH was adjusted to 10 with a solution of 37.1 g of sodium carbonate and 120 g of sodium hydroxide dissolved in 1 L of pure water. A precipitate was quickly formed, but stirring was continued for 1 hour while keeping the temperature at 40° C. Aging was then carried out at 95° C. for 24 hours. After cooling, the precipitate was washed with pure water, thus giving a hydrotalcite compound (hereinafter, called compound G). When an analysis was carried out on this compound, it was found to be Mg_{4.2}Al₂(OH)_{12.4}CO₃·3.5H₂O.

A powder X-ray diffraction (XRD) measurement of this compound was carried out. The diffraction pattern thereof is shown in FIG. 7. The compound was found to have a hydrotalcite peak, and the peak intensity at 2θ=11.52° was 6,100 cps.

### Example 8

153.8 g of magnesium nitrate hexahydrate and 75.0 g of aluminum nitrate nonahydrate were dissolved in 200 mL of pure water, and while maintaining this solution at 40° C. the pH was adjusted to 13 with a solution of 73.1 g of sodium carbonate and 120 g of sodium hydroxide dissolved in 1 L of pure water. A precipitate was quickly formed, but stirring was continued for 1 hour while keeping the temperature at 40° C. Aging was then carried out at 95° C. for 24 hours. After cooling, the precipitate was washed with pure water, thus giving a hydrotalcite compound (hereinafter, called compound H). When an analysis was carried out on this compound, it was found to be Mg₆Al₂(OH)₁₆CO₃·4H₂O.

A powder X-ray diffraction (XRD) measurement of this compound was carried out. The diffraction pattern thereof is shown in FIG. 8. The compound was found to have a hydrotalcite peak, and the peak intensity at 2θ=11.52° was 5,000 cps.

### Example 9

‘Compound I’ was obtained as the inorganic ion scavenger of the present invention by mixing compound A of Example 1 and α-zirconium phosphate (Zr(HPO₄)₂·H₂O) as an inorganic cation exchanger at a ratio by weight of 7:3.

### Example 10

‘Compound J’ was obtained as the inorganic ion scavenger of the present invention by mixing compound A of Example 1 and H type NASICON zirconium phosphate (HZr₂(PO₄)₃) as an inorganic cation exchanger at a ratio by weight of 7:3.

### Comparative Example 1

The commercial hydrotalcite compound DHT-4A, manufactured by Kyowa Chemical Industry Co., Ltd, was used as comparative compound 1. The chemical formula thereof is Mg_{4.3}Al₂(OH)_{12.6}CO₃·mH₂O. A powder X-ray diffraction (XRD) measurement of this compound was carried out. The diffraction pattern thereof is shown in FIG. 9. Comparative compound 1 was found to have a hydrotalcite peak, and the peak intensity at 2θ=11.52° was 8,000 cps.

### Comparative Example 2

The commercial hydrotalcite compound Kyoward 500, manufactured by Kyowa Chemical Industry Co., Ltd, was used as comparative compound 2. The chemical formula thereof is Mg₆Al₂(OH)₁₆CO₃·4H₂O. A powder X-ray diffraction (XRD) measurement of this compound was carried out. The diffraction pattern thereof is shown in FIG. 10. Comparative compound 2 was found to have a hydrotalcite peak, and the peak intensity at 2θ=11.52° was 1,000 cps.

### Comparative Example 3

The commercial hydrotalcite compound Kyoward 1000, manufactured by Kyowa Chemical Industry Co., Ltd, was used as comparative compound 3. The chemical formula thereof is Mg_{4.5}Al₂(OH)₁₃CO₃·3.5H₂O. A powder X-ray diffraction (XRD) measurement of this compound was carried out. The diffraction pattern thereof is shown in FIG. 11. Comparative compound 3 was found to have a hydrotalcite peak, and the peak intensity at 2θ=11.52° was 1,000 cps.

### Comparative Example 4

134.6 g of magnesium nitrate hexahydrate and 93.8 g of aluminum nitrate nonahydrate were dissolved in 200 mL of ion exchanged water and, while keeping this solution at 25° C., the pH of this solution was adjusted to 10 with a solution of 73.1 g of sodium carbonate and 120 g of sodium hydroxide dissolved in 1 L of ion exchanged water. Aging was then carried out at 205° C. for 6 hours. After cooling, a precipitate was washed with ion exchanged water, thus giving a hydrotalcite compound (hereinafter, called comparative compound 4). When this compound was analyzed, it was found to be Mg_{4.2}Al₂(OH)_{12.4}CO₃·3.5H₂O.

Furthermore, a powder X-ray diffraction (XRD) measurement of this compound was carried out. The diffraction pattern thereof is shown in FIG. 12. Comparative compound 4 was found to have a hydrotalcite peak, and the peak intensity at 2θ=11.52° was 10,000 cps.

### Comparative Example 5

39.17 g of sodium hydroxide (NaOH content 96%) and 11.16 g of sodium carbonate (Na₂CO₃ content 99.7%) were added to 1 L of water while stirring, and this was heated to 40° C. Subsequently, aqueous solution A prepared by adding 61.28 g of magnesium chloride (19.73% as MgO), 37.33 g of aluminum chloride (20.48% as Al₂O₃), and 2.84 g of ammonium chloride (31.46% as NH₃) to 500 mL of distilled water so that the Mg/AI molar ratio became 2.0 and the NH₃/Al molar ratio became 0.35 was gradually poured into the above. The pH when the pouring in was completed was 10.2. A reaction was further carried out at a temperature of 40° C. to 90° C. for about 20 hours while stirring. After the reaction was completed, 3.27 g of stearic acid was added so as to carry out a surface treatment reaction while stirring. A reaction suspension thus obtained was filtered, washed with water, then dried at 70° C., and subsequently ground with a small-size sample mill, thus giving comparative compound 5. When this compound was analyzed, it was found to be Mg₄Al₂(OH)₁₂CO₃·3.5H₂O.

Furthermore, a powder X-ray diffraction (XRD) measurement of this compound was carried out. The diffraction pattern thereof is shown in FIG. 13. Comparative compound 5 was found to have a hydrotalcite peak, and the peak intensity at 2θ=11.52° was 3,000 cps.

### Comparative Example 6

36.34 g of reagent-grade sodium hydroxide (NaOH content 96%) and 9.90 g of reagent-grade sodium carbonate (Na₂CO₃ content 99.7%) were added to 1 L of water while stirring, and while heating and maintaining this at 40° C. an aqueous solution prepared by adding 78.49 g of reagent-grade magnesium nitrate (MgO content 15.4%), 48.04 g of reagent-grade aluminum nitrate (Al₂O₃ content 14.15%), and 1.01 g of reagent-grade ammonium chloride (NH₃ content 31.46%) to 500 mL of distilled water so that the Mg/AI molar ratio was 2.25 and the NH₃/Al molar ratio was 0.14 was gradually poured thereinto. The pH when the pouring in was completed was 10.8. After a reaction was carried out at the same temperature for 1 hour while stirring, a reaction was carried out at 90° C. for 18 hours; after the reaction was completed 1.72 g of reagent-grade stearic acid was added thereto, and a surface treatment reaction was carried out at the same temperature for 2 hours while stirring. A reaction suspension thus obtained was filtered, washed with water, then dried at 70° C., and subsequently ground using a small-size sample mill, thus giving a hydrotalcite compound (hereinafter, called comparative compound 6). When this compound was analyzed, it was found to be Mg_{4.5}Al₂(OH)₁₃CO₃·3.5H₂O.

Furthermore, a powder X-ray diffraction (XRD) measurement of this compound was carried out. The diffraction pattern thereof is shown in FIG. 14. Comparative compound 6 was found to have a hydrotalcite peak, and the peak intensity at 2θ=11.52° was 2,300 cps.

### Comparative Example 7

Comparative compound 7 was obtained as a white fine powder in the same manner as in Comparative Example 5 except that a reaction was carried out with 37.00 g of reagent-grade sodium hydroxide (NaOH content 96%) without adding ammonium chloride, and the pH when pouring in was completed was 10.1. When this compound was analyzed, it was found to be Mg₄Al₂(OH)₁₂CO₃·3.5H₂O.

Furthermore, a powder X-ray diffraction (XRD) measurement of this compound was carried out. The diffraction pattern thereof is shown in FIG. 15. Comparative compound 7 was found to have a hydrotalcite peak, and the peak intensity at 2θ=11.52° was 3,000 cps.

### Basic Physical Properties of Ion Scavenger

### Measurement of BET Specific Surface Area

The specific surface area of compound A was measured by the ‘method for measuring the specific surface area of powders (solids) by gas adsorption’ of JIS Z8830. The results are shown in Table 1.

Similarly, compounds B, C, D, E, F, G, and H prepared in Examples 2 to 8 and comparative compounds 1 to 7 prepared in Comparative Examples 1 to 7 were subjected to measurement of specific surface area. The results are also shown in Table 1.

### Measurement of Average Secondary Particle Size

The secondary particle size of compound A obtained above was measured by a ‘Microtrac MT3000’ laser diffraction particle size analyzer manufactured by Nikkiso Co., Ltd., and the average particle size was determined. The results are shown in Table 1. Similarly, compounds B, C, D, E, F, G, and H prepared in Examples 2 to 8 and comparative compounds 1 to 7 prepared in Comparative Examples 1 to 7 were subjected to measurement of average secondary particle size. The results are also shown in Table 1.

### Measurement of Average Primary Particle Size

Furthermore, compounds A to H obtained above and comparative compounds 1 to 7 obtained in Comparative Examples 1 to 7 were subjected to measurement of primary particle size using a ‘JSM-6330F’ scanning electron microscope (JEOL). The results are given also in Table 1.

### Measurement of Chloride Ion Exchange Capacity

1.0 g of compound A was placed in a 100 mL polyethylene bottle, 50 mL of a 0.1 mol/L concentration aqueous solution of hydrochloric acid was charged thereinto, and the bottle was hermetically sealed and agitated at 40° C. for 24 hours. Subsequently, this solution was filtered using a 0.1 μm pore size membrane filter, and the chloride ion concentration in the filtrate was measured by ion chromatography. This chloride ion value was divided by a value obtained by measuring a chloride ion concentration by carrying out the same operation without adding the hydrotalcite compound, thus giving the chloride ion exchange capacity (meq/g). The results are given also in Table 2.

Compounds B, C, D, E, F, G, H, I, and J prepared in Examples 2 to 10 and comparative compounds 1 to 7 prepared in Comparative Examples 1 to 7 were similarly treated and chloride ion exchange capacity (meq/g) was determined. The results are also shown in Table 2.

### Ion Chromatography Analysis Conditions

Measurement equipment: model DX-300 manufactured by DIONEX
Separating column: lonPac AS4A-SC (manufactured by DIONEX)
Guard column: lonPac AG4A-SC (manufactured by DIONEX)
Eluent: 1.8 mM Na₂CO₃/1.7 mM NaHCO₃ aqueous solution
Flow rate: 1.5 mL/min
Suppressor: ASRS-I (recycle mode)

Chloride ion was measured under the analysis conditions given above.

### Measurement of Amount of Impurity Ions Leaching Out (Amount of Ionic Impurities)

5.0 g of compound A was placed in a 100 mL sealable polytetrafluoroethylene pressure-resistant container, 50 mL of ion exchanged water was further added thereto, and the container was sealed and treated at 125° C. for 20 hours. After cooling, this solution was filtered using a membrane filter having a pore size of 0.1 μm, and the sulfate ion, nitrate ion, and chloride ion concentrations of the filtrate were measured by ion chromatography (nitrate ion and chloride ion were measured in addition to sulfate ion under the analysis conditions given above. Measurement below was carried out by the same method). Furthermore, sodium ion and magnesium ion concentrations in the filtrate were measured by ICP. The numerical value obtained by multiplying the sum of the measurement values by 10 was defined as the amount of ionic impurities. The result is given in Table 2.

Similarly, compounds B, C, D, E, F, G, H, I, and J prepared in Examples 2 to 10 and comparative compounds 1 to 7 prepared in Comparative Examples 1 to 7 were subjected to measurement of the amount of impurity ions leaching out. The results are also shown in Table 2.

### Measurement of Electrical Conductivity of Supernatant

5.0 g of hydrotalcite compound A was placed in a 100 mL sealable polytetrafluoroethylene pressure-resistant container, 50 mL of ion exchanged water was further added thereto, and the container was sealed and treated at 125° C. for 20 hours. After cooling, this solution was filtered using a membrane filter having a pore size of 0.1 μm, and the electrical conductivity (μS/cm) of the filtrate were measured. The result is given in Table 2.

Similarly, compounds B, C, D, E, F, G, H, I, and J prepared in Examples 2 to 10 and comparative compounds 1 to 7 prepared in Comparative Examples 1 to 7 were subjected to measurement of electrical conductivity of the supernatant. The results are also shown in Table 2.

TABLE 1

| | | BET | | |
|---|---|---|---|---|
| | XRD | specific | Primary | Secondary |
| | peak intensity | surface area | particle size | particle size |
| | (cps) | (m²/g) | (nm) | (μm) |
| Example 1 | 6,500 | 32 | 120 | 0.18 |
| Example 2 | 6200 | 40 | 80 | 0.15 |
| Example 3 | 5,800 | 55 | 60 | 0.09 |
| Example 4 | 5,000 | 45 | 70 | 0.1 |
| Example 5 | 4,000 | 58 | 55 | 0.09 |
| Example 6 | 4,500 | 42 | 75 | 0.1 |
| Example 7 | 6,100 | 40 | 80 | 0.12 |
| Example 8 | 5,000 | 37 | 90 | 0.11 |
| Comp. Ex. 1 | 8,000 | 13 | 400 | 0.6 |
| Comp. Ex. 2 | 1,000 | 110 | 30 | 16 |
| Comp. Ex. 3 | 1,000 | 72 | 50 | 26 |
| Comp. Ex. 4 | 10,000 | 5 | 900 | 0.9 |
| Comp. Ex. 5 | 3,000 | 40 | 90 | 0.12 |
| Comp. Ex. 6 | 2,300 | 55 | 60 | 7.1 |
| Comp. Ex. 7 | 3,000 | 42 | 85 | 0.11 |

TABLE 2

| | Chloride ion | | Electrical |
|---|---|---|---|
| | exchange | Ionic impurity | conductivity |
| | capacity (meq/g) | amount (ppm) | (μS/cm) |
| Example 1 | 3.2 | <100 | 120 |
| Example 2 | 3.2 | <100 | 140 |
| Example 3 | 2.0 | <100 | 170 |
| Example 4 | 2.5 | 320 | 190 |
| Example 5 | 2.6 | 300 | 190 |
| Example 6 | 2.5 | 310 | 190 |
| Example 7 | 2.3 | 200 | 200 |
| Example 8 | 2.6 | 330 | 200 |
| Example 9 | 2.1 | <100 | 60 |
| Example 10 | 2.1 | <100 | 80 |
| Comp. Ex. 1 | 2.2 | 300 | 350 |
| Comp. Ex. 2 | 0.3 | 800 | 580 |
| Comp. Ex. 3 | 0.2 | 1000 | 620 |
| Comp. Ex. 4 | 3.1 | <100 | 100 |
| Comp. Ex. 5 | 3.4 | 380 | 350 |
| Comp. Ex. 6 | 3.1 | 500 | 450 |
| Comp. Ex. 7 | 3.3 | 400 | 370 |

### Example 11

### Test for Corrosion of Aluminum Wiring

### Preparation of Sample

72 parts by weight of a bisphenol epoxy resin (EPICOAT 828: epoxy equivalent weight 190, Japan Epoxy Resins), 28 parts by weight of an amine-based curing agent (KAYAHARD AA: molecular weight 252, Nippon Kayaku Co., Ltd.), 100 parts by weight of fused silica, 1 part by weight of an epoxy-based silane coupling agent (KBM-403, Shin-Etsu Chemical Co., Ltd.), and 0.25 parts by weight of compound A were combined and mixed using a three roll mill. This mixture was further subjected to vacuum degassing at 35° C. for 1 hour.

The resin thus mixed was applied onto two lines of aluminum wiring printed on a glass sheet (line width 20 μm, coating thickness 0.15 μm, length 1,000 mm, line gap 20 μm, resistance about 9 kΩ) at a thickness of 1 mm, and cured at 120° C., thus giving aluminum wiring sample A.

### Test for Corrosion

The epoxy-coated aluminum wiring sample A thus prepared was subjected to a pressure cooker test (PCT). The equipment used and the conditions were as follows.

Equipment used: EHS-211M, ESPEC CORP.
Test conditions: 130° C.±2° C., 85% RH (±5%)
Applied voltage: 20V,
Time: 60 hours

The resistance of positive electrode aluminum wiring was measured, and an evaluation was made based on the percentage change in resistance between that before and that after the PCT. The degree of corrosion of aluminum wiring was examined from the reverse side using a microscope. The results are shown in Table 3.

### Example 12

A PCT was carried out for aluminum wiring sample B prepared by repeating the same procedure as in Example 11 except that compound B was used instead of compound A. The results are shown in Table 3.

### Example 13

A PCT was carried out for aluminum wiring sample C prepared by repeating the same procedure as in Example 11 except that compound C was used instead of compound A. The results are shown in Table 3.

### Example 14

A PCT was carried out for aluminum wiring sample D prepared by repeating the same procedure as in Example 11 except that compound D was used instead of compound A. The results are shown in Table 3.

### Example 15

A PCT was carried out for aluminum wiring sample E prepared by repeating the same procedure as in Example 11 except that compound E was used instead of compound A. The results are shown in Table 3.

### Example 16

A PCT was carried out for aluminum wiring sample F prepared by repeating the same procedure as in Example 11 except that compound F was used instead of compound A. The results are shown in Table 3.

### Example 17

A PCT was carried out for aluminum wiring sample G prepared by repeating the same procedure as in Example 11 except that compound G was used instead of compound A. The results are shown in Table 3.

### Example 18

A PCT was carried out for aluminum wiring sample H prepared by repeating the same procedure as in Example 11 except that compound H was used instead of compound A. The results are shown in Table 3.

### Example 19

A PCT was carried out for aluminum wiring sample I prepared by repeating the same procedure as in Example 11 except that compound I was used instead of compound A. The results are shown in Table 3.

### Example 20

A PCT was carried out for aluminum wiring sample J prepared by repeating the same procedure as in Example 11 except that compound J was used instead of compound A. The results are shown in Table 3.

### Comparative Example 8

A PCT was carried out for comparative aluminum wiring sample 1 prepared by repeating the same procedure as in Example 11 except that comparative compound 1 was used instead of compound A. The results are shown in Table 3.

### Comparative Example 9

A PCT was carried out for comparative aluminum wiring sample 2 prepared by repeating the same procedure as in Example 11 except that comparative compound 2 was used instead of compound A. The results are shown in Table 3.

### Comparative Example 10

A PCT was carried out for comparative aluminum wiring sample 3 prepared by repeating the same procedure as in Example 11 except that comparative compound 3 was used instead of compound A. The results are shown in Table 3.

### Comparative Example 11

A PCT was carried out for comparative aluminum wiring sample 4 prepared by repeating the same procedure as in Example 11 except that comparative compound 4 was used instead of compound A. The results are shown in Table 3.

### Comparative Example 12

A PCT was carried out for comparative aluminum wiring sample 0 prepared by repeating the same procedure as in Example 11 except that no hydrotalcite compound was used. The results are shown in Table 3.

### Comparative Example 13

A PCT was carried out for comparative aluminum wiring sample 5 prepared by repeating the same procedure as in Example 11 except that comparative compound 5 was used instead of compound A. The results are shown in Table 3.

### Comparative Example 14

A PCT was carried out for comparative aluminum wiring sample 6 prepared by repeating the same procedure as in Example 11 except that comparative compound 6 was used instead of compound A. The results are shown in Table 3.

### Comparative Example 15

A PCT was carried out for comparative aluminum wiring sample 7 prepared by repeating the same procedure as in Example 11 except that comparative compound 7 was used instead of compound A. The results are shown in Table 3.

TABLE 3

| | Percentage change | |
|---|---|---|
| | in positive electrode | Corrosion state of aluminum |
| | resistance (%) | wiring (microscope) |
| Example 11 | 0.6 | Slightly corroded |
| Example 12 | 0.4 | Corrosion not observed |
| Example 13 | 0.4 | Corrosion not observed |
| Example 14 | 0.9 | Slightly corroded |
| Example 15 | 0.6 | Corrosion not observed |
| Example 16 | 0.7 | Corrosion not observed |
| Example 17 | 1.0 | Some corrosion |
| Example 18 | 1.0 | Some corrosion |
| Example 19 | 0.4 | Corrosion not observed |
| Example 20 | 0.4 | Corrosion not observed |
| Comp. Ex. 8 | 2.0 | Large amount of corrosion |
| Comp. Ex. 9 | ∞ | Open circuit due to corrosion |
| Comp. Ex. 10 | ∞ | Open circuit due to corrosion |
| Comp. Ex. 11 | 4.0 | Strongly corroded |
| Comp. Ex. 12 | ∞ | Open circuit due to corrosion |
| Comp. Ex. 13 | 1.5 | Large amount of corrosion |
| Comp. Ex. 14 | 2.2 | Large amount of corrosion |
| Comp. Ex. 15 | 1.6 | Large amount of corrosion |

When the percentage change in resistance exceeded 10%, most of the samples were open circuit. Compared with Examples 11 to 16, in which the precipitate formation temperature was 25° C., in Examples 17 and 18 employing compounds G and H, which were produced with a precursor precipitate formation temperature of 40° C., since the percentage change in resistance was slightly larger and there was slight corrosion, they were relatively inferior but within the scope of being applicable in practice. In Examples 19 and 20, which employed a cation exchanger in combination, the percentage change in resistance was smaller than in the case where a hydrotalcite was used on its own, and they were excellent.

### Example 21

60 parts of a bisphenol A epoxy resin (product name: Araldite AER-2502, Asahi Ciba Co., Ltd.) as an epoxy resin, 30 parts of butylphenyl glycidyl ether as a reactive diluent, 20 parts of an epoxy/amine addition product (epoxy/amine adduct) (product name: Novacure HX-3721, Asahi Kasei Corporation) as a curing agent, 1 part of an organically modified bentonite as a thixotropy-imparting agent, 30 parts of talc as an inorganic filler, 8 parts of a synthetic zeolite, 0.5 parts of a red pigment, and 3 parts of compound A were mixed, and the solid particles were dispersed uniformly in the resin using a three roll mill, thus giving an epoxy resin composition as an adhesive for surface mounting. The composition thus prepared was subjected to evaluation in terms of insulation reliability, thread-forming properties, coating shape, adhesion, and gelling time, and the evaluation results are given in Table 4 with respect to the main components of the composition.

### Example 22

An epoxy resin composition was prepared in the same manner as in Example 21 except that 3 parts of compound I was added instead of compound A. Evaluation was carried out in the same manner as in Example 21, and the results are given in Table 4.

### Comparative Example 16

An epoxy resin composition was prepared in the same manner as in Example 21 except that no hydrotalcite compound was added. Evaluation was carried out in the same manner as in Example 21, and the results are given in Table 4.

### Insulation Reliability

Surface insulation resistance was measured in accordance with JIS-Z-3197 for cured materials of the epoxy resin compositions prepared in Examples 21 and 22 and Comparative Example 16.

That is, a type II comb-shaped substrate was coated with the composition by a screen printing method at a coating thickness of 100 to 150 μm, and curing was carried out by heating at 150° C. for 10 min. The insulation resistance of the untreated substrate thus obtained was measured using a picoammeter (value A). Subsequently, this substrate was boiled in water for 2 hours and allowed to stand at 25° C. and 60% RH for 1 hour, and the insulation resistance was remeasured (value
B). This Evaluation was Made as Follows:
   ‘good’ for A/B≦10²,
   ‘fair for 10²<A/B≦10³, and
   ‘poor’ for 10³<A/B. The results are given in Table 4.

### Thread-Forming Properties

Coating tests were carried out on a glass epoxy substrate (FR-4), on the entire surface of which a solder resist had been printed and cured, using a dispenser with epoxy resin compositions prepared in Examples 17 and 18 and Comparative Example 16 at 0.15 mg per point at a coating speed of 50 msec per point continuously for 1,000 points; when even one mark due to thread-forming properties was observed on the substrate it was defined as ‘poor’, and when there were none it was defined as ‘good’.

### Coating Shape

The shape of the epoxy resin composition used for coating in evaluation of the thread-forming properties above was a cone shape, and a diameter D of the bottom face of this cone and a height H of the cone were examined and measured using a microscope. When the ratio H/D of height to diameter was

0.5 or less, it was defined as ‘poor’,
when in the range of 0.5 to 1.5, it was defined as ‘good’, and
when 1.5 or greater, it was defined as ‘fair’.

### Adhesion

2125 resistor chips were adhered to a glass epoxy substrate, on the entire surface of which a solder resist had been printed and cured, in the same manner as for evaluation of thread-forming properties, and the force required to pull off one chip was measured using a push-pull gauge. That is, the epoxy resin compositions prepared in Examples 17 and 18 and Comparative Example 16 were applied at 0.3 mg per chip and cured by heating in an oven at 150° C. for 3 min.

Gelling Time 0.3±0.05 g of the epoxy resin compositions prepared in Examples 17 and 18 and Comparative Example 16 were heated on a hot plate at 150° C., and the time (sec) taken for the flow state to disappear and gelling to be completed was measured.

TABLE 4

| Main components and | | | Comp. |
|---|---|---|---|
| evaluation results | Example 21 | Example 22 | Ex. 16 |
| Bisphenol A epoxy resin | 60 | 60 | 60 |
| Reactive diluent | 30 | 30 | 30 |
| Epoxy/amine adduct | 20 | 20 | 20 |
| Organically modified bentonite | 1 | 1 | 1 |
| Talc | 30 | 30 | 30 |
| Synthetic zeolite | 8 | 8 | 8 |
| Red pigment | 0.5 | 0.5 | 0.5 |
| Compound A | 3 | — | — |
| Compound I | — | 3 | — |
| Insulation reliability | Good | Good | Poor |
| Thread-forming properties | Good | Good | Good |
| Coating shape | Good | Good | Good |
| Adhesion (kg) | 4.5 | 4.5 | 4.1 |
| Gelling time (sec.) | 60 | 60 | 60 |

### Example 23

A liquid crystal sealing material composition was prepared using the formulation and steps below. 100 parts of a bisphenol A epoxy resin (product name: Araldite AER-2502, Asahi Ciba Co., Ltd.) as an epoxy resin, 40 parts of an epoxy/amine adduct (product name: Novacure HX-3721, Asahi Kasei Corporation) as a curing agent, 60 parts of titanium oxide (product name: Tipaque R-630, Ishihara Sangyo Kaisha Ltd.) as a filler, 5 parts of colloidal silica (product name: Aerosil R-974, Nippon Aerosil Co., Ltd.), and 3 parts of compound A were heated to 40° C. and mixed in a Dalton mixer by stirring for 30 min. Subsequently, three roll milling was carried out five times, it was confirmed that the particle size of the contents was no greater than 5 μm using a grind gauge, and 1.5 parts of a silica spacer having a particle size of 5 μm was added and dispersed uniformly, thus giving a composition as a liquid crystal sealing material.

The liquid crystal sealing material composition obtained here was printed by screen printing on a seal portion of an ITO (transparent electrode)-equipped glass substrate, leaving a liquid crystal encapsulation opening. Subsequently, preliminary drying and fusion to the substrate were carried out by heating to 80° C. and holding for 3 min, and it was then returned to room temperature. Subsequently, it was superimposed on a counter electrode side glass substrate and compressed by a thermal press heated at 130° C. for 10 min, thus curing the liquid crystal sealing material composition. After the empty panel thus obtained was evacuated, liquid crystal (ZL11636, Merck) was injected, the encapsulation opening was sealed by a sealing material, and curing was carried out, thus giving a liquid crystal panel.

This liquid crystal panel was evaluated in terms of liquid crystal alignment and memory properties (proportion of transmitted light intensity that can be retained over time relative to the intensity immediately after application of a pulse voltage; this decreases in the presence of impurities). The liquid crystal alignment was evaluated visually by the width of a black band occurring in the vicinity of the sealing material when the liquid crystal panel was heated to 80° C. without application of voltage and examined through a polarizing plate. When the width was 0.5 mm or less it was defined as ‘good’, when it was 0.5 to 1 mm it was defined as ‘fair’, and when it was 1 mm or greater it was defined as ‘poor’. The main components and the evaluation results for each liquid crystal sealing material composition are given in Table 5.

### Example 24

A liquid crystal sealing material composition was prepared in the same manner as for the composition of Example 23 except that 3 parts of compound I was added instead of compound A. Evaluation was carried out in the same manner as in Example 23, and the results are given in Table 5.

### Comparative Example 17

A liquid crystal sealing material composition was prepared in the same manner as for the composition of Example 23 except that compound A was not added. Evaluation was carried out in the same manner as in Example 23, and the results are given in Table 5.

TABLE 5

| Main components and | | | Comp. |
|---|---|---|---|
| evaluation results | Example 23 | Example 24 | Ex. 17 |
| Bisphenol A epoxy resin | 100 | 100 | 100 |
| Epoxy/amine adduct | 40 | 40 | 40 |
| Titanium oxide | 60 | 60 | 60 |
| Colloidal silica | 5 | 5 | 5 |
| Compound A | 3 | — | — |
| Compound I | — | 3 | — |
| Liquid crystal alignment | Good | Good | Poor |
| Memory properties (%) | 95 | 96 | 42 |

### Example 25

5 parts of compound A was added to 100 parts of a bisphenol A epoxy resin having an epoxy equivalent weight of 450 to 500 (product name: Araldite AER-2502, Asahi Ciba Co., Ltd.), 4 parts of dicyandiamide as an epoxy curing agent, 0.4 parts of benzyldimethylamine as a curing accelerator, and 60 parts of solvent (methyl ethyl ketone) were further added thereto, and stirring and mixing were carried out, thus giving a resin varnish composition. Subsequently, a 0.2 mm thick low alkali glass cloth for electrical use was impregnated with the resin varnish composition prepared above. Following this, it was dried at 160° C. for 5 min, thus giving a prepreg. This prepreg was cut into dimensions of 50 mm×50 mm, and six sheets thereof were superimposed and hot-pressed under initial conditions of 30 kg/cm², 160° C., and 15 min, and then conditions of 70 kg/cm², 165° C., and 1 hour, thereby giving an approximately 1.6 mm thick laminated sheet with a volume ratio of resin to glass cloth substrate of 50:50.

The laminated sheet was coated with a silver paste (Dotite XA208, Fujikura Kasei Co., Ltd.) by a screen printing method, and subjected to thermal curing at 130° C. for 1 hour, thus forming printed-wiring conductors (electrodes) in the shape of two facing combs. The shortest distance between these electrodes was 1 mm in all cases, and the thickness was about 20 μm. In order to evaluate the effect in preventing the occurrence of an electromigration phenomenon, a 100 V DC voltage was applied between the two comb-shaped electrodes while maintaining them at 40° C. and 95% RH, and the time taken for the insulation resistance between the electrodes to become 10⁶ Ω or lower was measured as the time for attaining a short circuit.

It was found that the time for attaining a short circuit was at least 3,000 hours.

### Example 26

A resin varnish composition of Example 26 was prepared by the same procedure by adding the same amount of compound I to the resin varnish of Example 25 instead of compound A, and a laminated sheet was prepared. When this laminated sheet was subjected to the same evaluation as in Example 25 it was found that the time taken to attain a short circuit was at least 3,000 hours.

### Comparative Example 18

A resin varnish composition of Comparative Example 18 was prepared by the same procedure without adding compound A to the resin varnish of Example 25, and a laminated sheet was prepared. When this laminated sheet was subjected to the same evaluation as in Example 25 it was found that the time taken to attain a short circuit was at least 160 hours.

In Table 1 and Table 2, Comparative Examples 2 and 3 show that conventional hydrotalcite compounds having a large specific surface area have a large amount of ionic impurities leaching out due to low crystallinity, and in Table 3 it is shown that the changes in resistance of Comparative Examples 9 and 10, which employ these hydrotalcite compounds, are very noticeable. Furthermore, the hydrotalcite compounds of Comparative Examples 1 and 4 have high crystallinity and a small amount of ionic impurities leaching out, but Table 3 shows that the changes in resistance of Comparative Examples 8 and 11, which employ these hydrotalcites, are large, and aluminum wiring is corroded. It is presumed that, since the hydrotalcites of Comparative Examples 1 and 4 have a small specific surface area, the ability to scavenge anions released from a resin portion is insufficient.

The amount of hydrotalcite compound added was 0.25 parts relative to 100 parts of resin in the Examples and Comparative Examples, and the above presumption is supported by the disclosure of Patent Publication 2 above that the effect is not exhibited when the amount of conventional hydrotalcite compound added is less than 1% relative to the resin.

In Table 1 and Table 2, the hydrotalcite compounds of Examples 1 to 8 all have a large specific surface area in the range of 30 to 70 m²/g and a high crystallinity of at least 3,500 cps. That is, they are superior to conventional hydrotalcite compounds in terms of achieving both large specific surface area and high crystallinity that far exceed a tradeoff line expected by analogy with conventional hydrotalcite compounds.

Moreover, compounds I and J, which are inorganic ion scavengers containing in combination the hydrotalcite compound of the present invention and an inorganic cation exchanger, have a small amount of ionic impurities and are excellent in terms of low electrical conductivity compared with a case in which the hydrotalcite is used on its own for measurement of electrical conductivity of the supernatant, as shown in Examples 9 and 10. In Examples 11 to 20, as shown in Table 3, since the change in resistance of aluminum wiring samples was small in all cases, it can be expected that the reliability will be high for an electronic component that is sealed by an electronic component-sealing resin composition employing the hydrotalcite compound of the present invention. In particular, Examples 19 and 20, which employ an inorganic ion scavenger containing in combination the hydrotalcite compound of the present invention and an inorganic cation exchanger, showed a smaller percentage change of positive electrode resistivity than Examples 11 to 18, which employed a hydrotalcite on its own. This suggests that the reliability of the electronic component will be increased, which is excellent.

Comparing Examples 21 to 26 with Comparative Examples 16 to 18, the electronic component-sealing resin compositions employing the hydrotalcite compound of the invention of the present application exhibited good physical properties, and when these compositions were applied to surface mounting, a liquid crystal seal, a laminated sheet, etc., high reliability was obtained.

Such a novel hydrotalcite compound is obtained by a novel production process that can be summarized as being a combination etc. of selection of a starting material that is not seen in the art and aging at low temperature for a long period of time. This production process is one that has been found with the target being quality, which is different from the conventional production processes that predominantly grow particles at high temperature and high pressure for a short period of time, and the effect of a hydrotalcite compound obtained by this production process in preventing corrosion is very good.

### INDUSTRIAL APPLICABILITY

The hydrotalcite compound and the inorganic ion scavenger of the present invention have a low amount of ionic impurities leaching out and a high ability to scavenge ions. When they are added to a resin composition, since there is a high effect in suppressing the adverse influence of ionic impurities originating from the outside and from the resin composition itself, the effect in suppressing corrosion of aluminum wiring is excellent. From the above, the hydrotalcite compound and the inorganic ion scavenger of the present invention can be used in various applications such as sealing, covering, insulating, etc. of electronic components and electrical components over a wide range, to thus enhance the reliability thereof. Furthermore, they also can be used in a stabilizer for a resin such as vinyl chloride, a corrosion inhibitor, etc.

### BRIEF DESCRIPTION OF DRAWINGS

FIG. 1 Powder X-ray chart of hydrotalcite compound of Example 1.

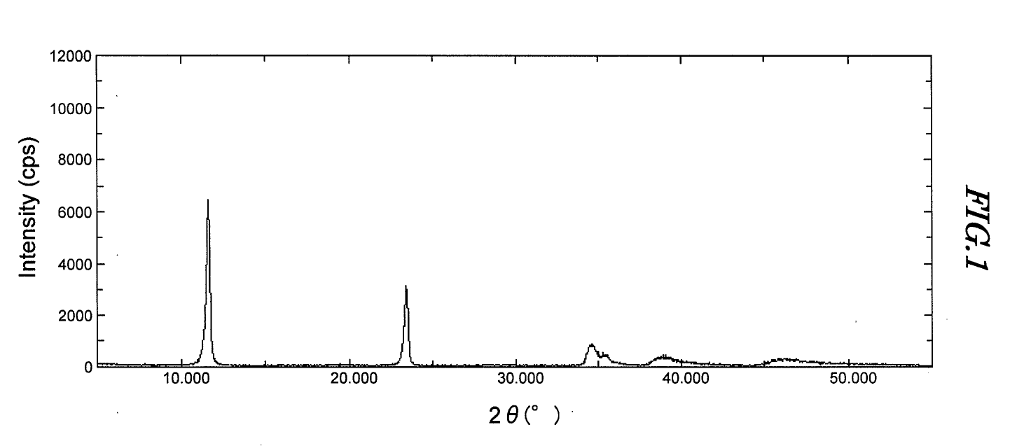

FIG. 2 Powder X-ray chart of hydrotalcite compound of Example 2.

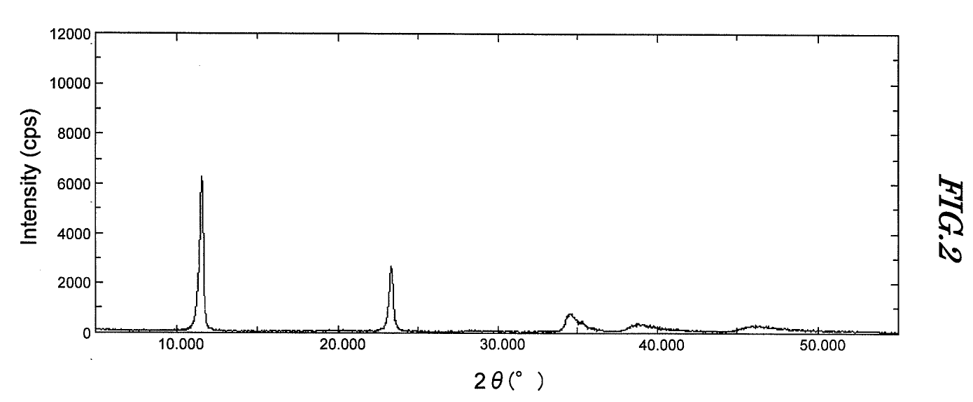

FIG. 3 Powder X-ray chart of hydrotalcite compound of Example 3.

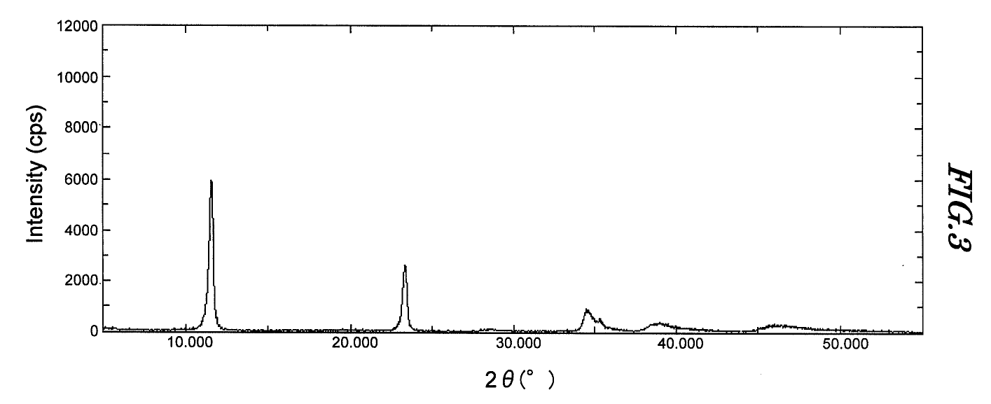

FIG. 4 Powder X-ray chart of hydrotalcite compound of Example 4.

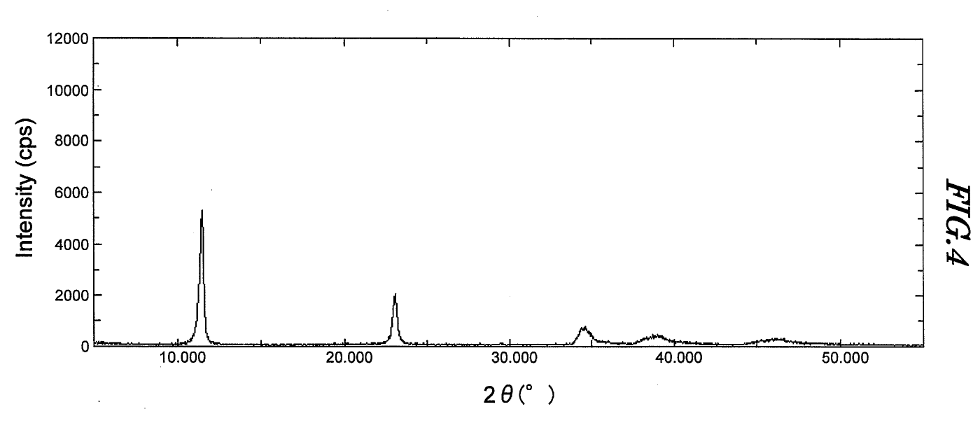

FIG. 5 Powder X-ray chart of hydrotalcite compound of Example 5.

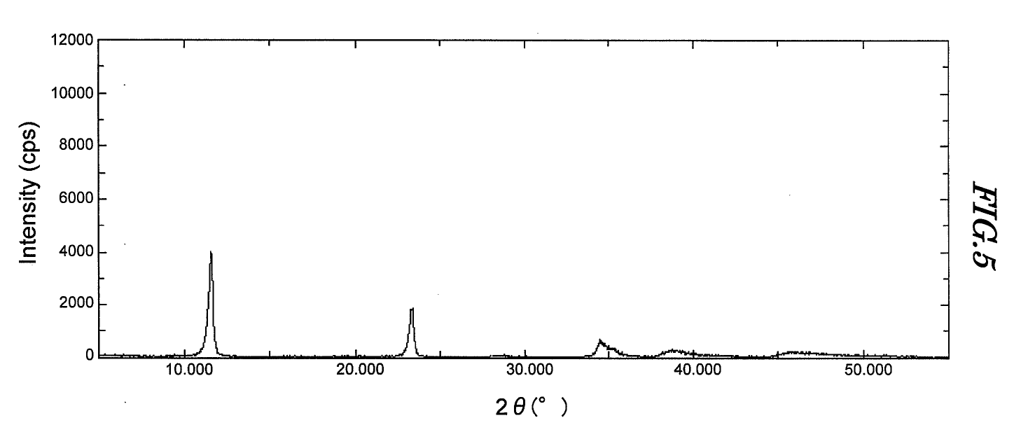

FIG. 6 Powder X-ray chart of hydrotalcite compound of Example 6.

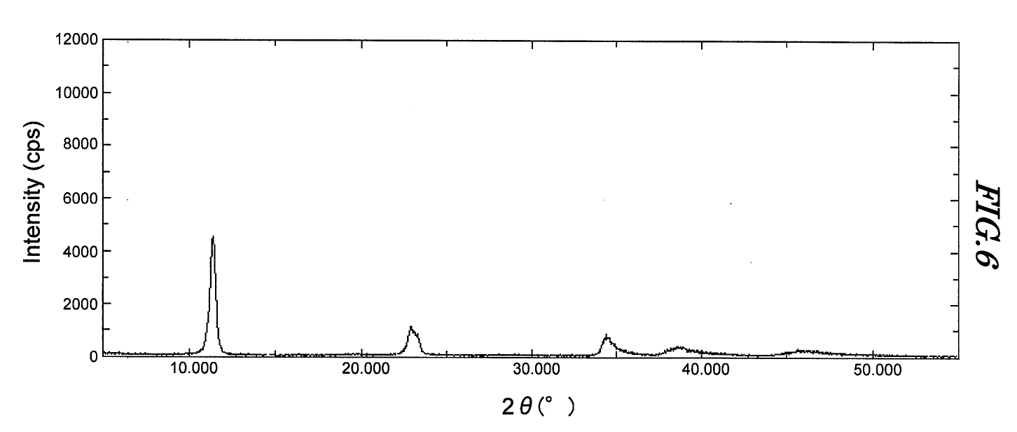

FIG. 7 Powder X-ray chart of hydrotalcite compound of Example 7.

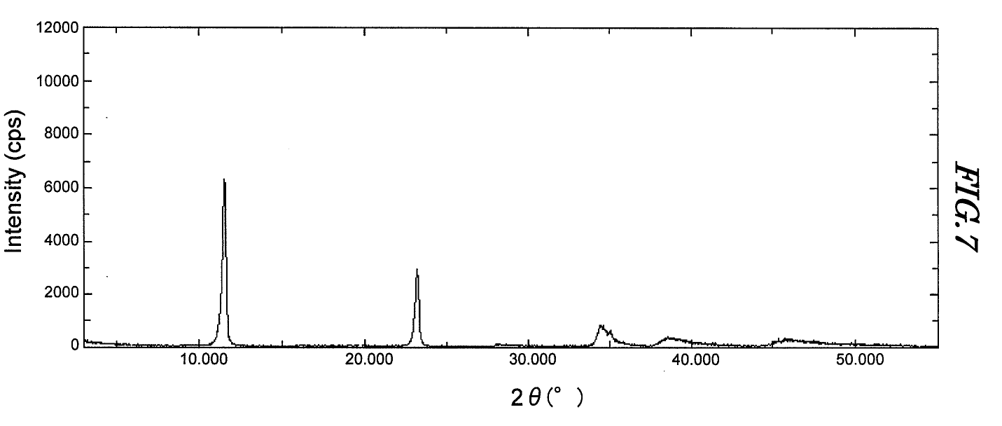

FIG. 8 Powder X-ray chart of hydrotalcite compound of Example 8.

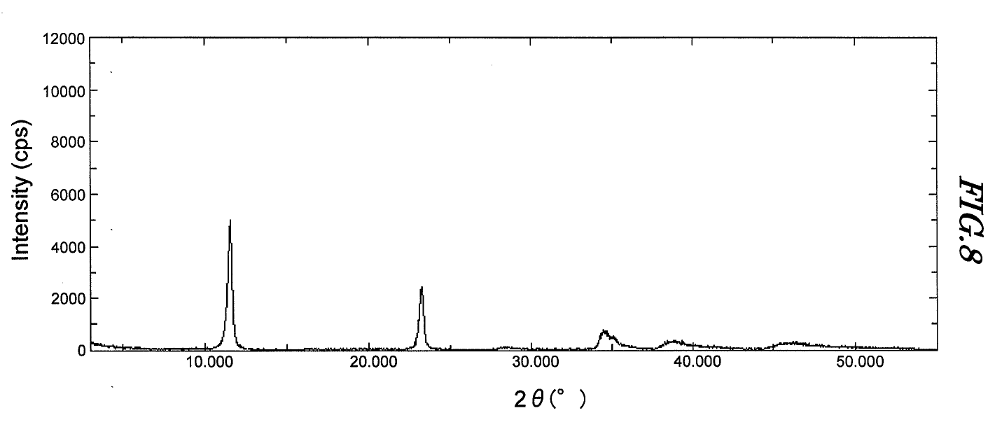

FIG. 9 Powder X-ray chart of hydrotalcite compound of Comparative Example 1.

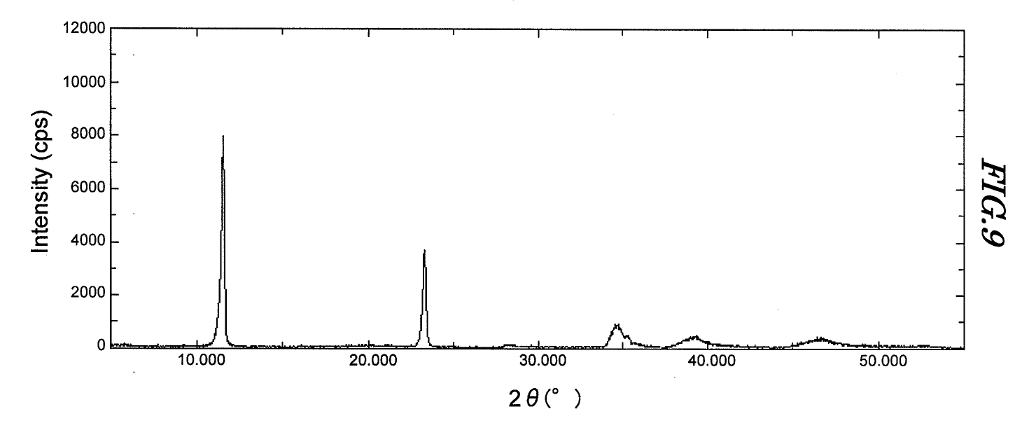

FIG. 10 Powder X-ray chart of hydrotalcite compound of Comparative Example 2.

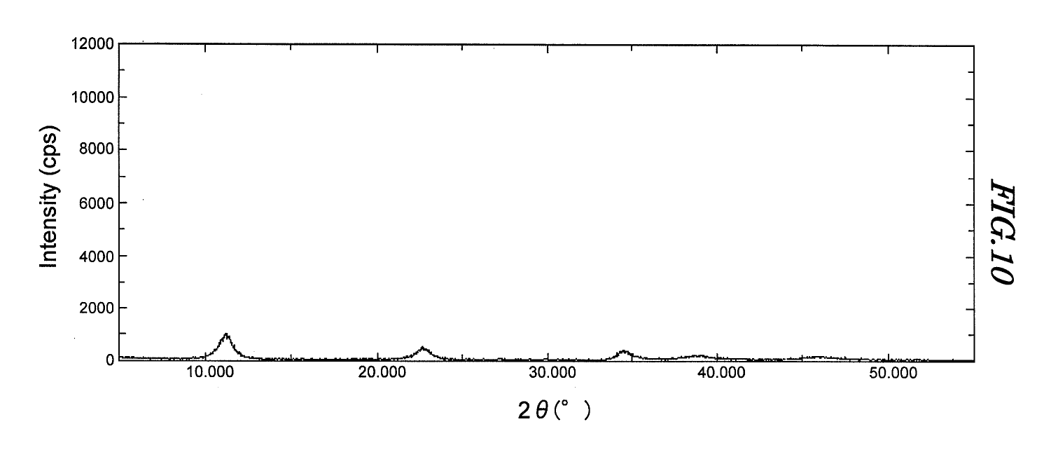

FIG. 11 Powder X-ray chart of hydrotalcite compound of Comparative Example 3.

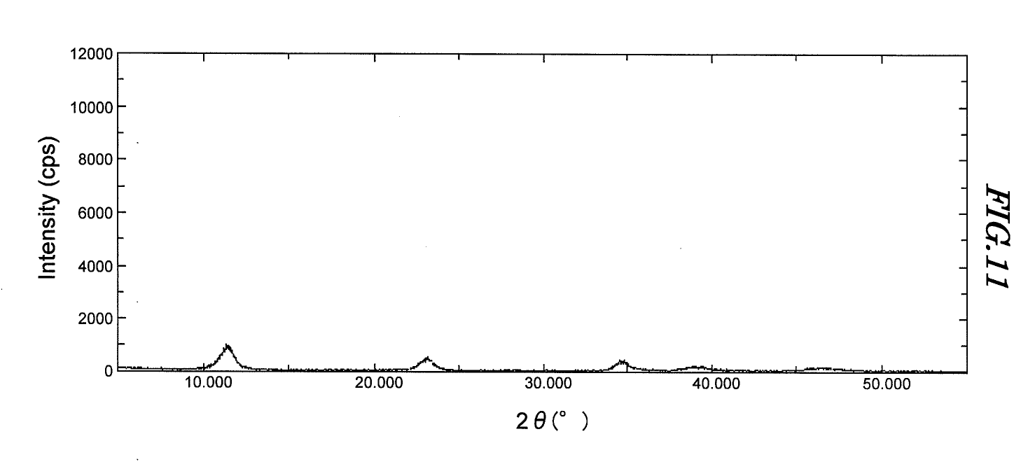

FIG. 12 Powder X-ray chart of hydrotalcite compound of Comparative Example 4.

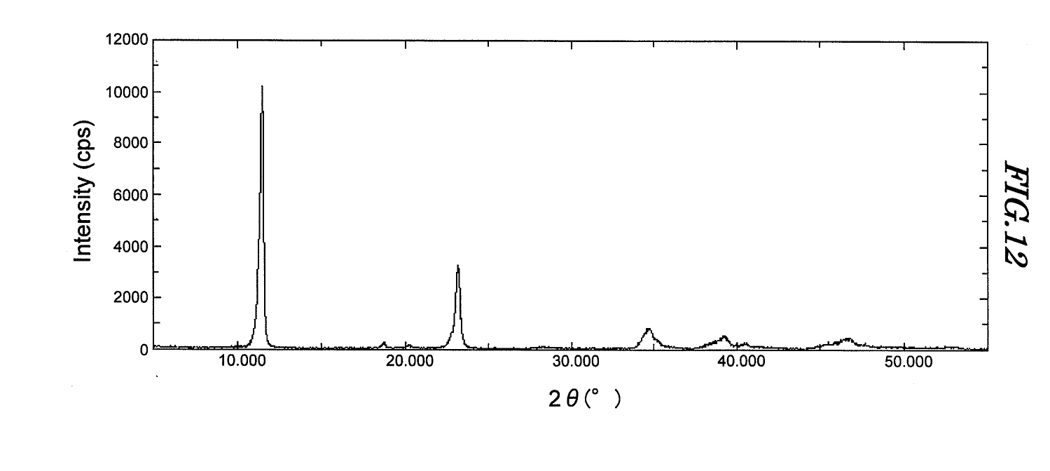

FIG. 13 Powder X-ray chart of hydrotalcite compound of Comparative Example 5.

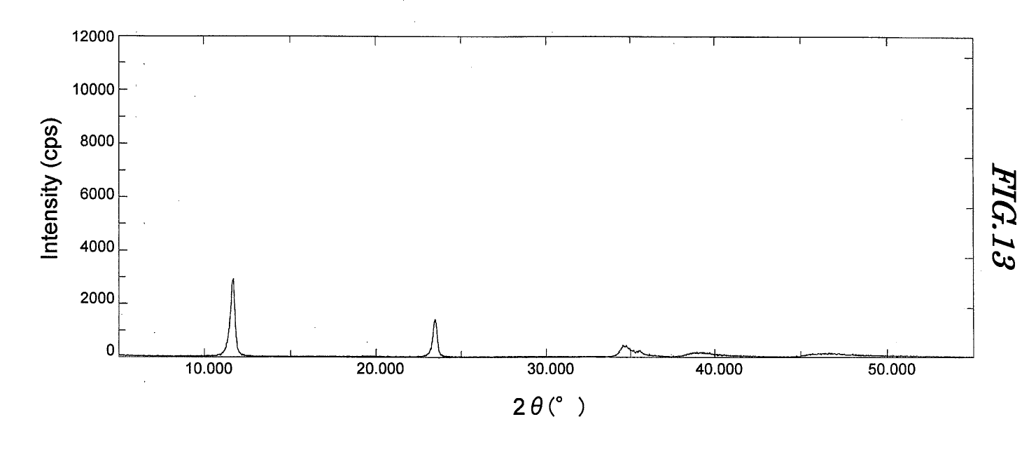

FIG. 14 Powder X-ray chart of hydrotalcite compound of Comparative Example 6.

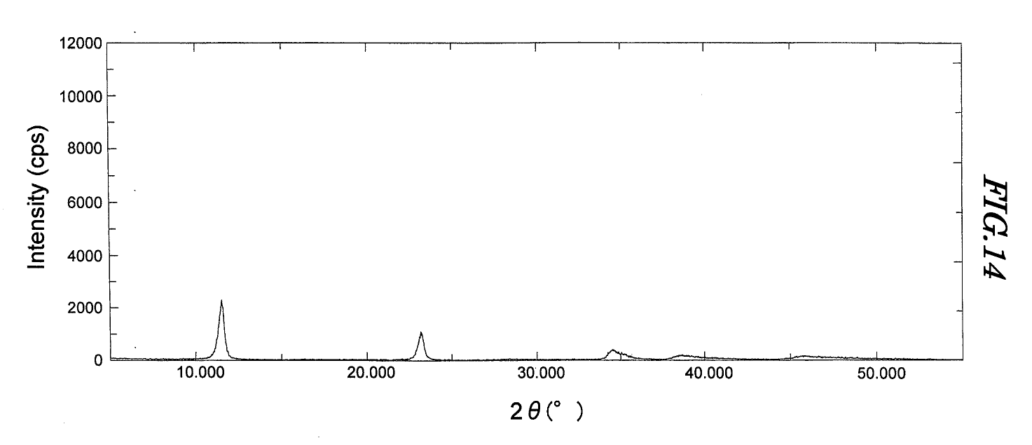

FIG. 15 Powder X-ray chart of hydrotalcite compound of Comparative Example 7.

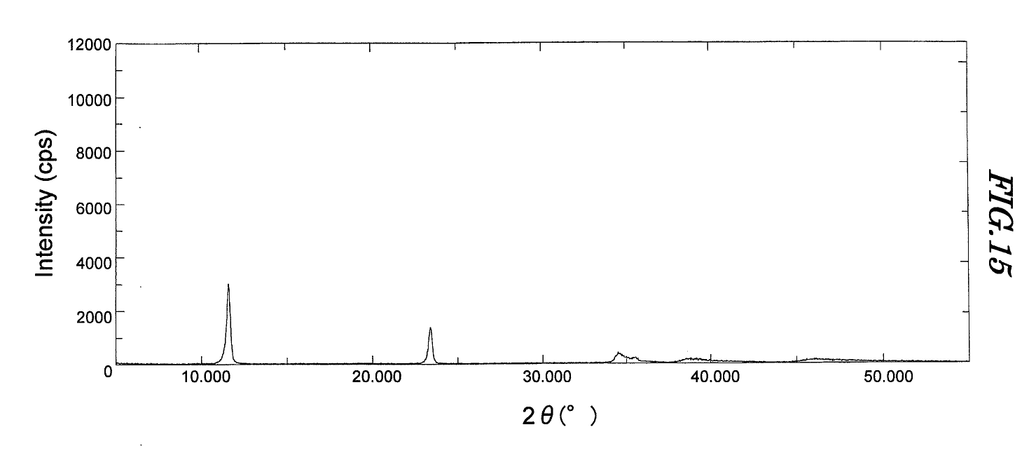

1. A hydrotalcitecompound represented by Formula (1),
the compound having in a powder X-ray diffraction pattern a hydrotalcite compound peak,
the peak intensity at 2θ=11.4° to 11.7° being at least 3,500 cps, and having a BET specific surface area of greater than 30 m²/g
MgₐAl_{b}(OH)_{c}(CO₃)_{d}·nH₂O (1)
in Formula (1), a, b, c, and d are positive numbers and satisfy 2a+3b−c−2d=0, and n denotes hydration number and is 0 or a positive number.

2. The hydrotalcite compound according to claim 1, wherein in Formula (1) above, a/b is at least 1.8 but no greater than 2.5.

3. The hydrotalcite compound according to claim 1, wherein the amount of ionic impurities leaching out when a leaching-out test is carried out in ion exchanged water at 125° C. for 20 hours is no greater than 500 ppm and the electrical conductivity of the leaching water is no greater than 200 μS/cm.

4. A process for producing the hydrotalcite compound according to claim 1, comprising in order:
a step of forming a hydrotalcite compound precursor precipitate from a metal ion aqueous solution, and
a step of heating at at least 70° C. but no greater than 150° C. for at least 5 hours but no greater than 40 hours.

5. The process for producing a hydrotalcite compound according to claim 4, wherein in the step of forming a hydrotalcite compound precursor precipitate, the metal ion aqueous solution has a temperature of at least 20° C. but no greater than 35° C.

6. The process for producing a hydrotalcite compound according to claim 4, wherein after the heating step it further comprises a step of drying at at least 200° C. but no greater than 350° C. for at least 0.5 hours but no greater than 24 hours.

7. An inorganic ion scavenger comprising the hydrotalcite compound according to claim 1 and an inorganic cation exchanger.

8. The hydrotalcite compound according to claim 1, wherein in an aluminum wiring corrosion test comprising the steps below, the increase in resistance is less than 1%,
A: a step of preparing an electronic component-sealing resin composition by combining 72 parts by weight of a bisphenol epoxy resin (epoxy equivalent weight 190), 28 parts by weight of an amine-based curing agent (molecular weight 252), 100 parts by weight of fused silica, 1 part by weight of an epoxy-based silane coupling agent, and 0.25 parts by weight of a hydrotalcite compound or an inorganic ion scavenger,
B: a step of preparing an aluminum wiring sample by mixing the electronic component-sealing resin composition prepared in step A using a three roll mill, subjecting it to vacuum degassing at 35° C. for 1 hour, then applying it onto two lines of aluminum wiring printed on a glass sheet (line width 20 μm, coating thickness 0.15 μm, length 1,000 mm, line gap 20 μm, resistance about 9 kΩ) at a thickness of 1 mm, and curing it at 120° C., and
C: step of measuring the resistance of aluminum wiring at a positive electrode between that before and that after putting the aluminum wiring sample prepared in step B in a pressure cooker under conditions of 130° C.±2° C., 85% RH (±5%), an applied voltage of 20V, and a time of 60 hours, and calculating the percentage change in resistance.

9. A composition comprising the hydrotalcite compound according to claim 1.

10. An electronic component-sealing resin composition comprising the hydrotalcite compound according to claim 1.

11. An electronic component-sealing resin composition comprising the inorganic ion scavenger according to claim 7.

12. An electronic component-sealing material formed by curing the electronic component-sealing resin composition according to claim 10.

13. An electronic component formed by the electronic component-sealing material according to claim 12 sealing a device.

14. The composition according to claim 9, wherein the composition is for use in a varnish, an adhesive, a paste, or a product comprising same.

15. The inorganic ion scavenger according to claim 7, wherein in an aluminum wiring corrosion test comprising the steps below, the increase in resistance is less than 1%,
A: a step of preparing an electronic component-sealing resin composition by combining 72 parts by weight of a bisphenol epoxy resin (epoxy equivalent weight 190), 28 parts by weight of an amine-based curing agent (molecular weight 252), 100 parts by weight of fused silica, 1 part by weight of an epoxy-based silane coupling agent, and 0.25 parts by weight of a hydrotalcite compound or an inorganic ion scavenger,
B: a step of preparing an aluminum wiring sample by mixing the electronic component-sealing resin composition prepared in step A using a three roll mill, subjecting it to vacuum degassing at 35° C. for 1 hour, then applying it onto two lines of aluminum wiring printed on a glass sheet (line width 20 μm, coating thickness 0.15 μm, length 1,000 mm, line gap 20 μm, resistance about 9 kΩ) at a thickness of 1 mm, and curing it at 120° C., and
C: a step of measuring the resistance of aluminum wiring at a positive electrode between that before and that after putting the aluminum wiring sample prepared in step B in a pressure cooker under conditions of 130° C.±2° C., 85% RH (±5%), an applied voltage of 20V, and a time of 60 hours, and calculating the percentage change in resistance.

16. A composition comprising the inorganic ion scavenger according to claim 7.

17. An electronic component-sealing material formed by curing the electronic component-sealing resin composition according to claim 11.

18. An electronic component formed by the electronic component-sealing material according to claim 17 sealing a device.

19. The composition according to claim 16, wherein the composition is for usein a varnish, an adhesive, a paste, or a product comprising same.
